(19) United States
(12) Patent Application Publication
(10) Pub. No.: US 2009/0057612 A1
(43) Pub. Date: Mar. 5, 2009

(54) PHOSPHOR AND METHOD FOR MANUFACTURING THE SAME

(75) Inventors: Makoto HOSOBA, Isehara (JP); Rie MATSUBARA, Isehara (JP); Yasuo NAKAMURA, Tokyo (JP); Takahiro KAWAKAMI, Atsugi (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/190,207

(22) Filed: Aug. 12, 2008

(30) Foreign Application Priority Data
Aug. 31, 2007 (JP) 2007-225301

(51) Int. Cl. C09K 11/08; C09K 11/54; C09K 11/66; C09K 11/68

(52) U.S. Cl. 252/301.5; 252/301.4 R; 252/301.6 R; 252/301.4 F

(57) ABSTRACT

It is an object to provide a novel phosphor which can be manufactured without using a defect formation step which is difficult to control, and a manufacturing method thereof. The phosphor has a structure including a phosphor host material and an emission excitation material which is dispersed in a marbled pattern in the phosphor host material while being in contact with it. The emission excitation material is selected from metal oxide, a semiconductor formed of an element belonging to Group 2B (Group 12) of the periodic table and an element belonging to Group 6B (Group 16) of the periodic table, or an element formed of an element belonging to Group 3B (Group 13) of the periodic table and an element belonging to Group 5B (Group 15) of the periodic table. The phosphor host material and the emission excitation material are mixed and baked with pressure to be joined.

### BACKGROUND OF THE INVENTION

1. Field of the Invention

The present invention relates to a phosphor and a method for manufacturing the phosphor. The present invention also relates to an EL element using the phosphor, and a light-emitting device and an electronic device which are provided with the EL element.

2. Description of the Related Art

In recent years, as various types of interior lighting and a light source for a flat panel display, a self-emission electroluminescence (hereinafter also referred to as “EL”) element has been actively developed. Since an EL element enables higher luminance, plane emission, reduction in thickness, and higher flexibility, it has been attracting attention as a new, next-generation light source. In addition, an EL element has been expected to be applied to a face of a watch, a membrane switch, an electric spectacular display, and the like as well as lighting, and has partially been put into practical use.

EL elements are classified according to whether their light-emitting materials are an inorganic compound or an organic compound. In general, the former is referred to as an inorganic EL element, while the latter is referred to as an organic EL element.

Inorganic EL elements are classified into a dispersion-type inorganic EL element and a thin-film-type inorganic EL element according to their element structures. Moreover, inorganic EL elements can be classified into a DC voltage driving type inorganic EL element and an AC voltage driving type inorganic EL element according to their driving methods. Furthermore, as a light emission mechanism of an inorganic EL element, there are localized-type light emission that utilizes inner-shell electron transition of a metal ion and donor-acceptor recombination-type light emission that utilizes a donor level and an acceptor level.

The dispersion-type inorganic EL element is superior in that a plane emission element can be manufactured at a low cost by a simple method such as a screen printing method or a coating method. A ZnS:CuCl phosphor is known as a phosphor used in the dispersion-type inorganic EL element. Here, the ZnS:CuCl phosphor means a phosphor in which Cu and Cl elements which form a donor-acceptor level are added to ZnS. The Fischer model is proposed as a model diagram illustrating an emission mechanism of the ZnS:CuCl phosphor. Fischer found out that there was a structure, where light emission originates, at a grain boundary inside the ZnS:CuCl phosphor. He considered that, by application of voltage to the phosphor, exchange of electric charges occurs first between the ZnS:CuCl phosphor and the structure where light emission originates; and then the electric charges are recombined in accordance with inversion of AC voltage, which leads to light emission.

Fischer guessed that the structure where light emission originates is formed of a highly conductive material, based on the idea that the electric field would be concentrated on the structure, and guessed that the highly conductive material is precipitated copper sulfide. In other words, he guessed that, in manufacturing the ZnS:CuCl phosphor, a Cu element added to ZnS does not only form an emission level (a donor level or an acceptor level) but also serve as a supply source of a Cu element forming the structure, where light emission originates, into a crystal. Note that the structure where light emission originates is also referred to as the “Fischer structure”.

The Fischer structure is easily formed with crystal defects. Therefore, it is effective to form crystal defects inside a phosphor in advance in order to form many Fischer structures. As a formation method of crystal defects, a method in which stress on a phosphor is applied from the outside of a phosphor is generally known (for example, see Patent Document 1; Japanese Published Patent Application No. H6-330035 and Patent Document 2: Japanese Published Patent Application No. H11-193378).

### SUMMARY OF THE INVENTION

However, as for the method in which stress on a phosphor is applied from the outside of the phosphor to form crystal defects, the crystal defects are not formed when the stress applied to the phosphor is too low. Moreover, when the stress applied to the phosphor is too high, the crystals themselves which form the phosphor might be destroyed or too many crystal defects might be formed. When too many crystal defects exist in a phosphor, an excited phosphor is thermally deactivated. As a result, EL emission efficiency is decreased, which is not desirable.

Moreover, as for the method in which stress on a phosphor is applied from the outside of the phosphor to form crystal defects, it is difficult to control the number or the size of crystal defects, which results in variation in quality of obtained phosphors, an EL element using the phosphor, and the like. Furthermore, when a light-emitting device is manufactured using phosphors with variation in quality and an EL element using the phosphors, the reliability of the light-emitting device might also be degraded.

In view of the above-described problems, it is an object of the present invention to provide a novel phosphor which can be manufactured without using a formation step of crystal defects which is difficult to control and a method for manufacturing the phosphor. It is another object of the present invention to provide an EL element using the novel phosphor, and a light-emitting device and an electronic device which are provided with the EL element.

The inventors thought that a step which is difficult to control, such as a formation step of crystal defects in which stress on a phosphor is applied from the outside of the phosphor, would be unnecessary if a structure in which electric charges were exchanged through a grain boundary with a phosphor host material by application of voltage could be directly provided in the phosphor host material without using crystal defects.

The inventors found that a structure, in which an emission excitation material which is separated from a phosphor host material while being in contact with it and can exchange electric charges by application of voltage is dispersed in the phosphor host material without performing a defect formation step, functions as a phosphor. They also found the possibility of obtaining a phosphor with high luminance by dispersion of an emission excitation material in a marbled pattern in the phosphor host material. Hereinafter, in this specification, a structure in which an emission excitation material is dispersed in a phosphor host material and in which the emission excitation material is separated from the phosphor host material while being in contact with the phosphor host material is also referred to as a “composite structure”.

Moreover, the inventors found that a phosphor having a composite structure can be manufactured by mixture of a phosphor host material and an emission excitation material and baking of the mixture. Furthermore, they found that the emission excitation material can be dispersed in a marbled pattern by baking the mixture with pressure.

A phosphor host material may be selected in consideration of desired emission color. It is desirable that, as an emission excitation material of the present invention, at least one material is selected from the following: a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table.

One feature of the present invention disclosed in this specification is a phosphor including a phosphor host material and an emission excitation material which is dispersed in a marbled pattern in the phosphor host material and separated from the phosphor host material. The emission excitation material is selected from a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table.

Another feature of the present invention disclosed in this specification is a phosphor including a phosphor host material and an emission excitation material which is dispersed in a marbled pattern in the phosphor host material and separated from the phosphor host material. The emission excitation material is selected from a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table. In addition, a surface of the phosphor is formed of the phosphor host material.

In any of the above-described structures, the emission excitation material is preferably formed of emission excitation material particles whose average central grain sizes is smaller than that of particles having a composite structure formed of a phosphor host material and an emission excitation material. Moreover, one of the emission excitation material particles may be connected in series to another emission excitation material particle or separated from another emission excitation material particle.

In any of the above-described structures, in the case where a metal oxide is selected as the emission excitation material, the following can be used: zinc oxide, nickel oxide; tin oxide; titanium oxide; cobalt trioxide; cobalt oxide; tungsten oxide; molybdenum oxide; vanadium trioxide; vanadium pentoxide; indium tin oxide; indium oxide; rhenium trioxide; ruthenium oxide; strontium ruthenium oxide; strontium iridium oxide; or barium lead oxide. Zinc oxide can be used in the case where a semiconductor formed of an element belonging to Group 2B (Group 12) of the periodic table and an element belonging to Group 6B (Group 16) of the periodic table is selected as the emission excitation material. In addition, indium phosphide can be used in the case where a semiconductor formed of an element belonging to Group 3B (Group 13) of the periodic table and an element belonging to Group 5B (Group 15) of the periodic table is selected as the emission excitation material.

Another feature of the present invention disclosed in this specification is a manufacturing method in which a phosphor host material and an emission excitation material including a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table are mixed as raw materials, and the obtained mixture is baked with pressure.

Another feature of the present invention disclosed in this specification is a manufacturing method in which a phosphor host material and an emission excitation material including metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table are mixed; the obtained mixture is baked with pressure; and the obtained baked substance is immersed in a neutral, acid, or basic solution or exposed to a neutral, acid, or basic gas.

In any of the above-described structures, the baking with pressure is preferably performed by a hot pressing method, a hot isostatic pressing method, a discharge plasma sintering method, or an impact method. In addition, it is desirable that the raw materials be mixed by a wet process and the obtained mixed material be smashed so that the grain size thereof becomes small.

The present invention makes it possible to manufacture a phosphor having EL emission with high luminance and high efficiency. Moreover, phosphors with little variation in quality can be manufactured. Furthermore, by the present invention, higher luminance of an EL element and a light-emitting device and an electronic device which are provided with the EL element can be obtained.

### BRIEF DESCRIPTION OF THE DRAWINGS

In the accompanying drawings:

FIGS. 1A and 1B are schematic views illustrating an example of a phosphor of the present invention;

FIG. 2 is a flow chart illustrating an example of a method for manufacturing a phosphor of the present invention;

FIGS. 3A to 3C are each a cross-sectional schematic view of an example of an EL element of the present invention;

FIG. 4A is a top view of an example of a passive matrix light-emitting device of the present invention, and FIGS. 4B and 4C are each a cross-sectional view of an example of the same;

FIG. 5 is a perspective view of an example of a passive matrix light-emitting device of the present invention;

FIG. 6 is a top view of an example of a passive matrix light-emitting device of the present invention;

FIG. 7A is a top view of an example of an active matrix light-emitting device and FIG. 7B is a cross-sectional view of an example of the same;

FIGS. 8A and 8B are cross-sectional SIM images of a phosphor particle of Embodiment 1;

FIG. 9 is a graph showing characteristics of an EL element of Embodiment 1;

FIGS. 10A and 10B are cross-sectional SIM images of a phosphor particle of Embodiment 2;

FIG. 11 is a graph showing characteristics of an EL element of Embodiment 2;

FIG. 12 is a graph showing characteristics of an EL element of Embodiment 3;

FIG. 13 is a graph showing characteristics of an EL element of Embodiment 4;

FIG. 14 is a graph showing characteristics of an EL element of Embodiment 5;

FIG. 15 is a graph showing characteristics of an EL element of Embodiment 6;

FIG. 16 is a graph showing characteristics of an EL element of Embodiment 7;

FIG. 17 is a cross-sectional SIM image of a phosphor particle of Embodiment 8;

FIG. 18 is a graph showing characteristics of an EL element of Embodiment 8;

FIG. 19 is a cross-sectional SIM image of part of an EL element of Embodiment 8;

FIG. 20 is a schematic view illustrating a structure of an EL element of any of Embodiments 1 to 8;

FIGS. 21A to 21D are perspective views of examples of electronic devices of the present invention; and

FIG. 22 is an exploded view of an example of a liquid crystal display device in which a light-emitting device of the present invention is used as a light source.

### DETAILED DESCRIPTION OF THE INVENTION

Embodiment Modes of the present invention will be hereinafter described with reference to the accompanying drawings. Note that the present invention is not limited to the description below and it is easily understood by those skilled in the art that modes and details of the present invention can be modified in various ways without departing from the purpose and scope of the present invention. Therefore, the present invention should not be interpreted as being limited to the description below of Embodiment Modes. Note that, in the structures of the present invention described below, reference numerals denoting the same portions may be used in common in different drawings.

### Embodiment Mode 1

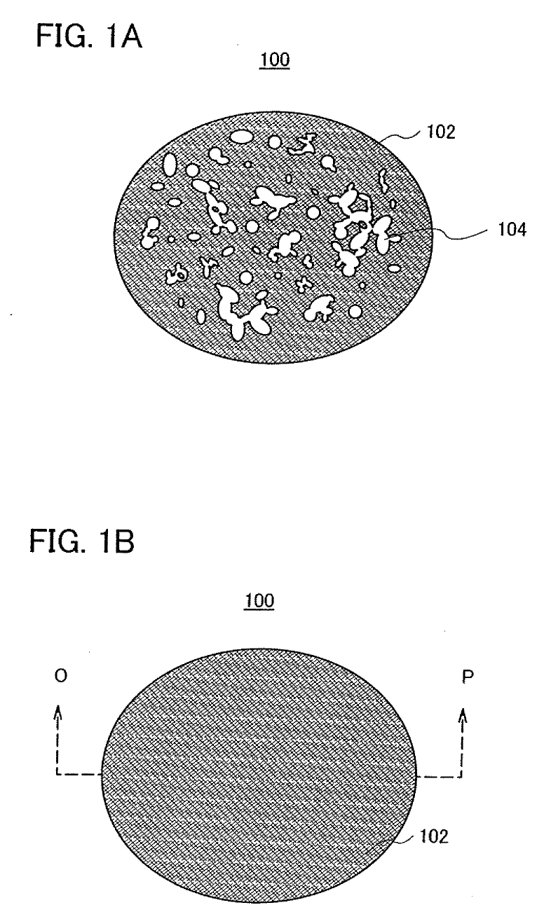

A phosphor of the present invention will be described. FIG. 1A is a cross-sectional schematic view showing an example of a phosphor 100 of the present invention. In addition, FIG. 1B is a perspective view of the phosphor 100 of the present invention, and FIG. 1A is a cross-sectional schematic view taken along the line O-P in FIG. 1B.

The phosphor 100 includes a phosphor host material 102 which emits phosphorescence and an emission excitation material 104. Such a phosphor 100 is also referred to as a “composite phosphor”. Although FIG. 1A shows the phosphor 100 in a particle state as an example, there is no particular limitation on the shape of the phosphor of the present invention. The phosphor of the present invention may have an irregular shape. In addition, the surface of the phosphor may be smooth or rough. The central grain size of the phosphor 100 is preferably 0.1 μm to 100 μm.

The emission excitation material 104 is included in the phosphor host material 102. In addition, the emission excitation material 104 is dispersed in a marbled pattern in the phosphor host material 102 and is separated from the phosphor host material 104 while being in contact with it.

The emission excitation material 104 is formed of a plurality of minute emission excitation material particles whose central grain sizes are each smaller than that of the phosphor 100. It is desirable that the average central grain size of the emission excitation material particle be several nm to several hundreds nm. Note that the plurality of emission excitation material particles may be particles each with the same shape or particles with different shapes or central grain sizes.

Note that the terms “grain”, “particle”, and “particle state” in this specification includes, in its category, an irregular shape without limitation to a symmetric round shape (a spherical shape).

In addition, as described above, the emission excitation material 104 is dispersed in a marbled pattern in the phosphor host material 102. The term “marbled pattern” in this specification means a state in which various grains are mixed and can also mean a state in which various grains are scattered. Moreover, various grains in a “marbled pattern” includes, in its category, a state in which the grains are separated from each other, a state in which the grains cohere, and a state in which the grains cohering are continued, and thus boundary surfaces cannot he distinguished.

FIG. 1A shows the emission excitation material 104 which is formed of emission excitation material particles which are separated and dispersed in a marbled pattern and formed of emission excitation material particles cohering to be connected, and thus boundaries cannot be distinguished. Note that the emission excitation material 104 may be formed of only separated emission excitation material particles or may be in a state in which emission excitation material particles cohere and cannot be distinguished.

In the phosphor 100, the emission excitation material 104 is separated from the phosphor host material 102 while being in contact with it, and also dispersed in the phosphor host material 102. An interface between the phosphor host material 102 and the emission excitation material 104 exists inside the phosphor 100. By application of voltage, the emission excitation material 104 gives and receives electric charges at an interface with the phosphor host material 102. Moreover, the emission excitation material 104 is dispersed in a marbled pattern in the phosphor host material 102, whereby a thin region is locally formed in the phosphor host material 102 in the phosphor 100. The thin region of the phosphor host material 102 is in contact with an interface of the emission excitation material 104 and a high electric field can be locally formed; according, light emission from the phosphor 100 can be easily obtained.

Note that, since the emission excitation material 104 with a marbled pattern formed of micro particles of emission excitation material is in a micro particle state, comparing with the case where the emission excitation material 104 is a bulk, the thickness of the phosphor host material 102 which fills in spaces can be reduced. Moreover, the interface between the emission excitation material 104 and the phosphor host material 102 can be increased. Thus, the phosphor host material 102 can locally have a high electric field, and accordingly luminance of EL emission can be increased.

Note that it is desirable that the emission excitation material 104 be dispersed uniformly and in a marbled pattern in the phosphor host material 102 which emits phosphorescence. This is because thin regions of the phosphor host material 102 are uniformly formed in the phosphor 100 by uniform dispersion of the emission excitation material 104 in a marbled pattern, and accordingly variations in regions which emit phosphorescence can be reduced.

The volume of each of the phosphor host material 102 and the emission excitation material 104 which are included in the phosphor 100 is preferably controlled as appropriate, depending on luminance or efficiency of EL emission which is to be obtained. In order to increase the luminance of EL emission, it is effective to disperse a lot of emission excitation materials in a marbled pattern and form high electric field regions. However, since the phosphor host material 102 plays a role of emitting phosphorescence, when the volume ratio of the phosphor host material 102 taking up the phosphor 100 is reduced, the size of a region which emits phosphorescence might be reduced and emission efficiency of the phosphor 100 might be decreased. Therefore, it is desirable to select the volume ratio of the phosphor host material 102 and the emission excitation material 104 so that higher luminance of the phosphor can be achieved without decrease in emission efficiency.

Moreover, it is desirable that the emission excitation material 104 be not exposed at the surface of the phosphor 100. In other words, the surface of the phosphor 100 is preferably formed of the phosphor host material 102. In the phosphor 100, the emission excitation material 104 exists in the phosphor host material 102 and is not exposed at the surface of the phosphor 100, whereby an electric field can be efficiently added to the inside of the phosphor 100.

A material having a desired emission color may be selected for the phosphor host material 102. In addition, an activator can also be added depending on desired emission color. The “phosphor host material” in this specification includes, in its category, both a phosphor host material which emits phosphorescence by itself and a phosphor host material to which an activator imparting a function of emitting phosphorescence is added.

As specific examples of the phosphor host material 102, the following can be given: (1) a phosphor host material formed of an element belonging to Group 2B (Group 12) of the periodic table and an element belonging to Group 6B (Group 16) of the periodic table; (2) a ternary material (a ternary phosphor host material) formed of an element belonging to Group 2B (Group 12) of the periodic table, an element belonging to Group 3B (Group 13) of the periodic table, and an element belonging to group 6B (Group 16) of the periodic table; (3) an oxide phosphor host material; (4) a silicate phosphor host material; (5) a halosilicate phosphor host material; (6) a phosphate phosphor host material; (7) a halophosphate phosphor host material; (8) a borate phosphor host material; (9) an aluminate and gallate phosphor host material; (10) a molybdate and tungstate phosphor host material; (11) a halide and oxyhalide phosphor host material; (12) a sulfate phosphor host material; and (13) a eutectic crystal of the above materials; (14) a mixture of the above materials; and the like.

As examples of (1) the phosphor host material formed of an element belonging to Group 2B (Group 12) of the periodic table and an element belonging to Group 6B (Group 16) of the periodic table, the following can be given: cadmium sulfide, cadmium selenide, cadmium telluride, zinc sulfide, zinc selenide, zinc telluride, calcium sulfide, magnesium sulfide, strontium sulfide, barium sulfide, and the like.

As examples of (2) the ternary material formed of an element belonging to Group 2B (Group 12) of the periodic table, an element belonging to Group 3B (Group 13) of the periodic table, and an element belonging to Group 6B (Group 16) of the periodic table, the following can be given: calcium thiogallate, barium thioaluminate, strontium thioaluminate, zinc thiogallate, ZnBa₂S₃, and the like.

As examples of (3) the oxide phosphor host material, the following can be given: calcium oxide, zinc oxide, thorium oxide, yttrium oxide, lanthanum oxide, and the like.

As examples of (4) the silicate phosphor host material, the following can be given: calcium silicate, magnesium silicate, zinc silicate, strontium silicate, barium silicate, yttrium silicate, calcium magnesium silicate, barium magnesium silicate, barium lithium silicate; and the like.

As examples of (5) the halosilicate phosphor host material, the following can be given: lanthanum chloride silicate, calcium chloride silicate, barium chloride halosilicate, and the like.

As examples of (6) the phosphate phosphor host material, the following can be given: yttrium phosphate, lanthanum phosphate, calcium phosphate or strontium phosphate, zinc phosphate, and the like.

As examples of (7) the halophosphate phosphor host material, the following can be given: calcium fluoride phosphate, calcium chloride phosphate, strontium fluoride phosphate, strontium chloride phosphate, and the like.

As examples of (8) the borate phosphor host material, the following can be given: yttrium borate, lanthanum borate, calcium borate, calcium yttrium borate, strontium borate, yttrium aluminum borate, calcium chloride borate, and the like.

As examples of (9) the aluminate and gallate phosphor host material, the following can be given: lithium aluminate, yttrium aluminate, lanthanum aluminate, calcium aluminate, zinc aluminate, gallate aluminate, calcium gallate, and the like.

As examples of (10) the molybdate and tungstate phosphor host material, calcium molybdtate, calcium tangstate, and the like can be given.

As examples of (11) the halide and oxyhalide phosphor host material, the following can be given: magnesium fluoride, calcium fluoride, calcium chloride, calcium iodide, yttrium oxybromide, yttrium oxychloride, yttrium oxyfluoride, and the like.

As examples of (12) the sulfate phosphor host material, magnesium sulfide, calcium sulfide, strontium sulfide, and the like can be given.

As an example of (13) the eutectic crystal of the above materials, a eutectic crystal of two or more materials selected from (1) to (12) is given. Note that the above-described two or more materials may be, for example, two materials selected from (1) the phosphor formed of an element belonging to Group 2B (Group 12) of the periodic table and an element belonging to Group 6B (Group 16) of the periodic table; one material selected from (1) the phosphor formed of an element belonging to Group 2B (Group 12) of the periodic table and an element belonging to Group 6B (Group 16) of the periodic table; or one material selected from (2) the ternary material formed of an element belonging to group 2B (Group 12), an element belonging to Group 3B (Group 13) of the periodic table, and an element belonging to Group 6B (Group 16) of the periodic table.

Similarly, as an example of (14) the mixture of the above materials, a mixture of two or more materials selected from (1) to (12) can be given.

As an example of the activator, a metal containing a rare-earth transition metal (e.g., Mn, Cu, Ag, or Au) or a compound containing a rare-earth transition element can also be added. Alternatively, a compound containing a representative element (e.g., Al, Ga, F, Cl, Br, or I) can be added. The rare-earth transition element functions as an emission center of localized emission, and the representative element forms an impurity level which brings donor-acceptor recombination emission.

For the emission excitation material 104, a material which plays a role of generating a local high electric field in the phosphor 100 may be selected. Alternatively, a material which is capable of giving and receiving electric charges at the interface with the phosphor host material 102 in the phosphor 100 may be selected.

As examples of the emission excitation material 104, the following can be given: (I) a metal oxide; (II) a semiconductor formed of an element belonging to Group 2B (Group 12) of the periodic table and an element belonging to Group 6B (Group 16) of the periodic table; (III) a semiconductor formed of an element belonging to Group 3B (Group 13) of the periodic table and an element belonging to Group 5B (Group 15) of the periodic table; (IV) the metal oxide or the semiconductor to which an impurity element is added; and the like.

As examples of (I) the metal oxide, the following can be given: zinc oxide, nickel oxide; tin oxide; titanium oxide; cobalt trioxide; cobalt oxide; tungsten oxide; molybdenum oxide; vanadium trioxide; vanadium pentoxide; indium tin oxide; indium oxide; rhenium trioxide; ruthenium oxide; strontium ruthenium oxide; strontium iridium oxide; barium lead oxide; and the like.

Zinc oxide and the like can be given as examples of (11) the semiconductor formed of an element belonging to Group 2B (Group 12) of the periodic table and an element belonging to Group 6B (Group 16) of the periodic table. Indium phosphide and the like can be given as examples of (II) the semiconductor formed of an element belonging to Group 3B (Group 13) of the periodic table and an element belonging to Group 5B (Group 15) of the periodic table.

As examples of (IV) the metal oxide or the semiconductor to which an impurity element is added, the following can be given: a metal oxide or a semiconductor in which a rare-earth transition element (e.g., Mn or Ir) is added to a material selected from (I) to (III); a metal oxide or a semiconductor in which a representative element (e.g., Al, Ga, Sn, or Mg) is added to a material selected from (I) to (III); and the like. Specifically, ZnO:Mn; ZnO:Ir, ZnO:Al, ZnO:Ga, In₂O₃,Sn, In₂O₃:Mg; and the like can be given.

Note that the material which can be selected for the phosphor host material 102 and the material which can be selected for the emission excitation material 104 partly overlap. Since the phosphor host material 102 and the emission excitation material 104 need to be separated from each other, the phosphor host material 102 and the emission excitation material 104 are selected for a combination in which the phosphor host material and the emission excitation material are not mixed with each other to form a solid solution.

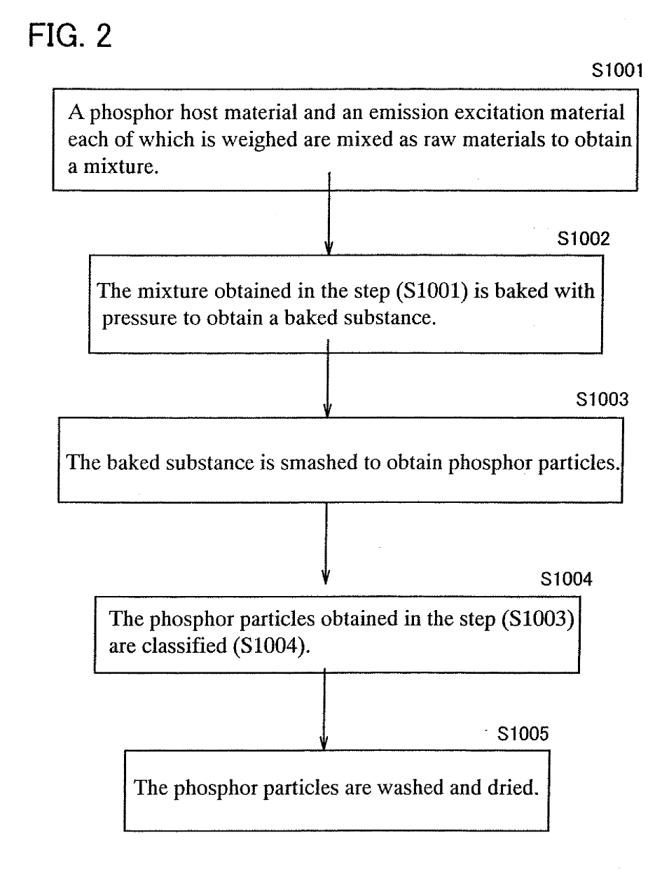

Next, examples of steps until the phosphor 100 is obtained are shown in a flow chart of FIG. 2.

A phosphor host material and an emission excitation material each of which is weighed are mixed as raw materials to obtain a mixture (S1001). The phosphor host material and the emission excitation material may be selected depending on desired emission color or the like. In addition, the mixture ratio is preferably selected so that higher luminance can be obtained without decrease in emission efficiency.

In the case where an activator is included in a phosphor, an activator and a phosphor host material are mixed and prebaked in advance to be used as a phosphor host material. Then, the phosphor host material to which the activator has been added and an emission excitation material are mixed. Alternatively, a phosphor host material and a material which is obtained in such a manner that an activator and an emission excitation material are mixed and prebaked in advance are mixed. Further alternatively, an activator, a phosphor host material, and an emission excitation material can be mixed together.

Note that the smaller the grain size of the mixture obtained in the step (S1001) is, the better it is. This is because when the grain size of a mixture is made small, the grain sizes of a phosphor host material and an emission excitation material also become small, and thus the number of interfaces between the phosphor host material and the emission excitation material included in a phosphor can be increased in manufacturing the phosphor. Therefore, it is desirable that the mixing step also serve as a smashing step, or a smashing step is performed before or after the mixing step. For example, a jet mill, a planetary pot mill, a mix rotor, a mortar, or the like can be used. It is desirable that smash be performed so that the central value of distribution of grain sizes of the phosphor host material becomes about 0.001 μm to 1 μm and the central value of distribution of grain sizes of the emission excitation material becomes about 0.001 μm to 1 μm.

Next, the mixture obtained in the step (S1001) is baked with pressure to obtain a baked substance (S1002). For the baking of the mixture, a hot pressing method, a hot isostatic pressing (HIP) method, a discharge plasma sintering method, or an impact method is preferably applied. Although the baking temperature is selected depending on the sintering temperature of the phosphor host material, the baking temperature is preferably about 500° C. to 2000° C., and the preferable temperature can be determined depending on a combination of the phosphor host material and the emission excitation material. Although the pressure and the time for the baking with pressure depend on materials of the mixture, it is preferable that the baking be performed at a pressure of about 20 Pa to 40 MPa for about 60 minutes.

EL emission can be obtained from the baked substance obtained through the above-described steps.

Although the substance itself obtained in the step (S1002) can function as a phosphor, the baked substance is smashed to obtain phosphor particles (S1003). A jet mill, a planetary pot mill, a mix rotor, a mortar, or the like can be used in order to smash the baked substance.

Next, the phosphor particles obtained in the step (S1003) are classified (S1004) The grain sizes of the phosphor particles are preferably the same, and the grain size is preferably less than or equal to 50 μm. A sieve having openings with a desired size, or the like can be used in order to classify the phosphor particles.

Next, the phosphor particles are washed and dried (S1005). The phosphor particles are preferably immersed in an acid, neutral, or basic solution or exposed to an acid, neutral, or basic gas in order to be washed. In the case where a main purpose is selectively removing emission excitation materials existing on the surface of the phosphor particles, a solution or a gas which is capable of removing emission excitation material particles by etching is selected. Note that a solution or a gas which does not react with other materials (such as the phosphor host material and the activator) which are included in the phosphor particle is selected.

Through the above-described steps, the phosphor particles with small and the same grain size can be obtained. Note that at least the steps of (S1001), (S1002), and (S1003) may be performed in order to obtain the phosphor of the present invention.

In manufacturing the phosphor, the phosphor host material and the emission excitation material are mixed (S1001), and then the mixture is baked (S1002); thus, the phosphor host material and the emission excitation material are joined. Accordingly, a phosphor having a composite structure can be manufactured. Moreover, by application of baking with pressure when a composite structure is formed, a phosphor having a composite structure in which the emission excitation material is dispersed in a marbled pattern in the phosphor host material can be manufactured.

The phosphor which can be manufactured through the above-described steps does not require a defect formation step in which pressure is applied from the outside of the phosphor to form crystal defects, which is a difficult step, and thus variation in quality of individual phosphors can be reduced. Moreover, with the phosphor having a composite structure in which an emission excitation material is dispersed in a marbled pattern in a phosphor host material, EL emission efficiency can be increased and higher luminance can be obtained.

Note that this embodiment mode can be combined with any of the other embodiment modes and embodiments as appropriate.

### Embodiment Mode 2

In this embodiment mode, an EL element using a phosphor will be described.

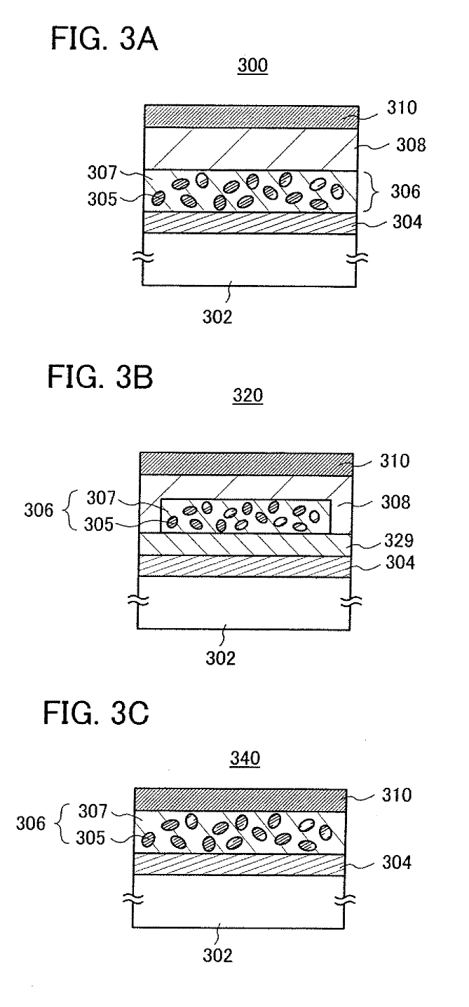

FIG. 3A shows an example of a dispersion-type EL element, in which a first electrode 304, a light-emitting layer 306, a dielectric layer 308, and a second electrode 310 are provided over a substrate 302. The light-emitting layer 306 has a structure in which a phosphor 305 is dispersed in a binder 307. As the phosphor 305, a phosphor having a composite structure in which an emission excitation material is dispersed in a marbled pattern in a phosphor host material, like the phosphor 100 described in Embodiment Mode 1, is used.

Examples of a structure of an EL element 300 and a manufacturing method thereof will be described. Here, an example will be described in which EL light emitted from the light-emitting layer 306 is extracted from the substrate 302 side.

The first electrode 304 is formed over the substrate 302. In this embodiment mode, since light is extracted from the substrate 302 side, a light-transmitting electrode is formed as the first electrode 304. Specifically, the first electrode 304 can be formed using indium tin oxide (ITO), indium tin oxide containing silicon or silicon oxide (ITSO: indium tin silicon oxide), indium zinc oxide (IZO), indium tin oxide containing tungsten oxide and zinc oxide (IWZO), or the like. For example, indium zinc oxide (IZO) can be formed by a sputtering method using a target in which 1 wt % to 20 wt % of zinc oxide is added to indium oxide. Indium tin oxide containing tungsten oxide and zinc oxide (IWZO) can be formed by a sputtering method using a target in which 0.5 wt % to 5 wt % of tungsten oxide and 0.1 wt % to 1 wt % of zinc oxide are contained in indium oxide. Note that, even if a material having low transmittance of visible light is used, the material can be used for a light-transmitting electrode by being formed to a thickness of greater than or equal to 1 nm and less than or equal to 50 nm, preferably greater than or equal to 5 nm and less than or equal to 20 nm.

The light-emitting layer 306 is formed over the first electrode 304. The light-emitting layer 306 is formed in such a manner that the phosphor 305 is dispersed in the binder 307. The phosphor 305 is the phosphor of the present invention and has a composite structure in which an emission excitation material is dispersed in a marbled pattern in a phosphor host material. As the binder 307, either an inorganic binder or an organic binder can be used. For example, a polymer. With a relatively high dielectric constant, such as a cyanoethyl cellulose-based resin, or a resin such as polyethylene, polypropylene, a polystyrene-based resin, a silicone resin, an epoxy resin, or a vinylidene fluoride resin can be used. The dielectric constant can be adjusted in such a manner that minute particles having a high dielectric constant, such as BaTiO₃ or SrTiO₃, are adequately mixed into such a resin. For a dispersion method of phosphor particles, a homogenizer, a planetary mixer, a roll mixer, an ultrasonic disperser, or the like can be used. A dispersion solution in which the phosphor 305 is dispersed in the binder 307 is applied onto the first electrode 304 by a spin coating method, a dip coating method, a bar coating method, a spray coating method, a screen printing method, a coating method, a slide coating method, or the like, whereby the light-emitting layer 306 can be formed.

The dielectric layer 308 is formed over the light-emitting layer 306. The dielectric layer 308 is formed using a material which has a high dielectric constant and a high insulating property and a high dielectric breakdown voltage. For example, the dielectric layer 308 can be formed using a metal oxide or a nitride, and the following is specifically used: BaTiO₃, TiO₂, SrTiO₃, PbTiO₃, KNbO₃, PbNbO₃, Ta₂O₃, BaTa₂O₆, LiTaO₃, Y₂O₃, Al₂O₃, ZrO₂, AlON, ZnS, or the like. The dielectric layer 308 may be formed as a uniform thin film, with use of such a material, or may be formed as a layer which has a particle structure in which fine particles of a high dielectric constant material are dispersed in a binder. The binder used in the dielectric layer 308 can be similar to the binder 307 used in the above-described light-emitting layer 306.

In the case where the dielectric layer 308 is formed as a uniform thin film, it can be formed by a sputtering method, an evaporation method, or the like. In the case where the dielectric layer 308 is formed by dispersion of fine particles of a high dielectric constant material in a binder, it can be formed by a spin coating method, a dip coating method, a bar coating method, a spray coating method, a screen printing method, a coating method, a slide coating method, or the like.

The second electrode 310 is formed over the dielectric layer 308. The second electrode 310 may be formed using a conductive material. The following is specifically given as the conductive material: aluminum, silver, gold, platinum, nickel, tungsten, chromium, molybdenum, iron, cobalt, copper, or palladium, a nitride of such a metal material (e.g., titanium nitride), and the like. The second electrode 310 can be formed by a coating method such as an ink jet method, an evaporation method, a sputtering method, or the like. In the case where light is extracted from the other electrode (the first electrode 304) side, as in this embodiment mode, the second electrode 310 is preferably an electrode with reflectivity. An electrode with reflectivity is formed as the second electrode 310, whereby light emitted from the light-emitting layer 306 can be efficiently extracted.

Note that in the dispersion-type EL element, a structure can also be employed in which a dielectric layer which is similar to the dielectric layer 308 is formed between the first electrode 304 and the light-emitting layer 306 so that the light-emitting layer is sandwiched between the dielectric layers. Alternatively, a structure can be employed in which a dielectric layer is also formed on side surfaces of the light-emitting layer so that the light-emitting layer is wrapped by the dielectric layers.

For example, FIG. 3B shows an example of an EL element 320 with a structure in which a light-emitting layer is sandwiched between dielectric layers, and the first electrode 304, a dielectric layer 329, the light-emitting layer 306, the dielectric layer 308, and the second electrode 310 are provided over the substrate 302. Here, a structure is shown in which the light-emitting layer 306 is sandwiched by the dielectric layer 329 and the dielectric layer 308 and is also wrapped by them. In addition, in the light-emitting layer 306, the phosphor 305 of the present invention is dispersed in the binder 307. The dielectric layer 329 can be formed using a similar material and by a similar method to the dielectric layer 308.

Moreover, FIG. 3C shows an example of an EL element 340 with a structure in which a dielectric layer is not formed and a light-emitting layer is sandwiched between a pair of electrodes, and the first electrode 304, the light-emitting layer 306, and the second electrode 310 are provided over the substrate 302. In the light-emitting layer 306, the phosphor 305 of the present invention is dispersed in the binder 307.

In this embodiment mode, since the dielectric layer is provided in the EL elements shown in FIGS. 3A and 3B, the EL elements can be driven with AC voltage. Since a dielectric layer is not provided in the EL element shown in FIG. 3C, the EL element can be driven with either a DC voltage or an AC voltage.

Note that, although the structure in which light emitted from the light-emitting layer is extracted through the first electrode and the substrate has been described in this embodiment mode, the present invention is not particularly limited to this structure. In the case where light is extracted from the second electrode side, a light-transmitting electrode may be formed as the second electrode and a reflective electrode may be formed as the first electrode. Alternatively, a structure may be employed in which a light-transmitting electrode is formed as both the first electrode and the second electrode so that light from the light-emitting layer is extracted in both directions.

Moreover, the structure of the EL element is not limited to those shown in FIGS. 3A to 3C. According to need, a layer which plays a role of increasing the orientation of the light-emitting layer, an injection layer which plays a role of injecting electrons or holes, or a transporting layer which plays a role of transporting electrons or holes may be provided.

The phosphor dispersed in the light-emitting layer has a composite structure in which an emission excitation material is dispersed in a marbled pattern in a phosphor host material. Higher luminance and higher efficiency of the phosphor can be obtained, and accordingly emission luminance and emission efficiency of an EL element in which the phosphor is dispersed can be increased. Moreover, the phosphor does not need a defect formation step which is difficult to control and variation in quality of individual phosphors is reduced, and thus variation in an emission of an EL element can be suppressed.

Note that this embodiment mode can be combined with any of the other embodiment modes and embodiments as appropriate.

### Embodiment Mode 3

In this embodiment mode, a light-emitting device provided with an EL element using a phosphor of the present invention will be described.

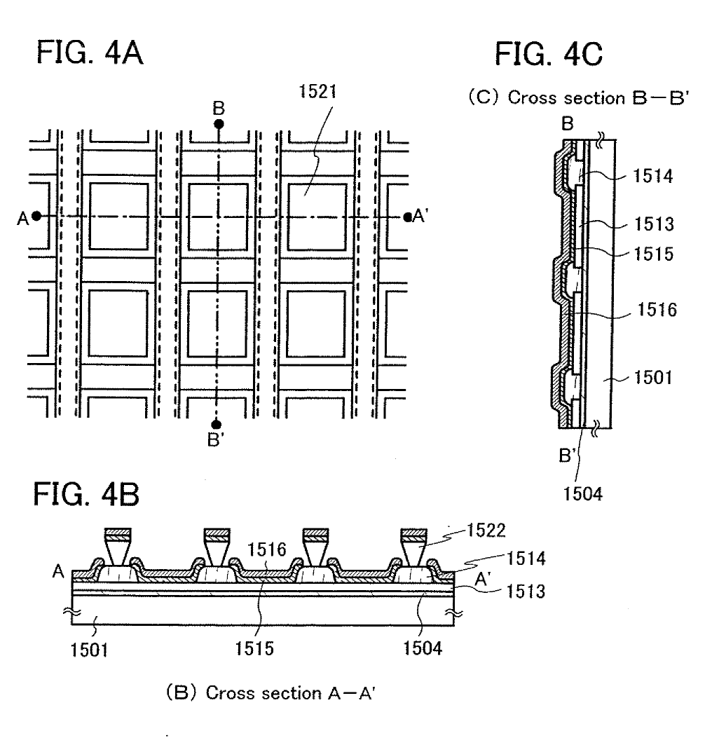

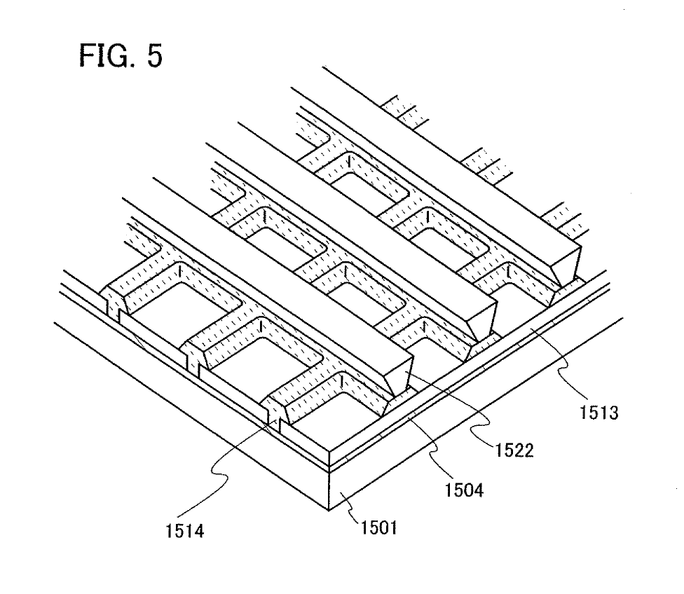

An example of a passive matrix (also referred to as “simple matrix”) light-emitting device is shown in FIGS. 4A to 4C and FIG. 5. In the passive matrix light-emitting device, a plurality of anodes arranged in parallel to each other and with a stripe shape (strip form) are provided perpendicularly to a plurality of cathodes arranged in parallel to each other and with a stripe shape, and a light-emitting layer is interposed at each intersection of the anode and the cathode. Thus, a pixel at an intersection of an anode which is selected (to which voltage is applied) and a cathode which is selected emits light.

FIG. 4A is a top view of a pixel portion before being sealed. FIG. 4B is a cross-sectional view taken along the line segment A-A′ in FIG. 4A, and FIG. 4C is a cross-sectional view taken along the line segment B-B′ in FIG. 4A.

An insulating layer 1504 is formed as a base insulating layer over a first substrate 1501. Note that the insulating layer 1504 is not necessarily formed if the base insulating layer is not needed. A plurality of first electrodes 1513 are arranged in stripes at regular intervals over the insulating layer 1504. A partition wall 1514 having opening portions corresponding to pixels is provided over the first electrodes 1513. The partition wall 1514 having opening portions is formed using an insulating material (a photosensitive or nonphotosensitive organic material (e.g., polyimide, acrylic, polyamide, polyimide amide, a resist, or benzocyclobutene) or an SOG film (e.g., a SiOₓ film including an alkyl group)). Note that each opening portion corresponding to a pixel is a light-emitting region 1521.

A plurality of inversely-tapered partition walls 1522 parallel to each other are provided over the partition wall 1514 having opening portions to intersect with the first electrodes 1513. The inversely-tapered partition walls 1522 are formed by a photolithography method using a positive-type photosensitive resin, portion of which unexposed to light remains as a pattern, and by adjustment of the amount of light exposure or the length of development time so that a lower portion of a pattern is etched more.

FIG. 5 shows a perspective view immediately after formation of the plurality of inversely-tapered partition walls 1522 which are parallel to each other. Note that the same reference numerals are used to denote the same portions as those in FIGS. 4A to 4C.

The total thickness of the partition wall 1514 having opening portions and the inversely-tapered partition wall 1522 is set so as to be larger than the total thickness of a layer including a light-emitting layer and a conductive layer which serves as a second electrode. When the EL layer and the conductive layer are stacked over the first substrate 1501 having the structure shown in FIG. 5, a plurality of separated regions each including an EL layer 1515 and a second electrode 1516 are formed, as shown in FIGS. 4A to 4C. Note that the plurality of separated regions are electrically isolated from one another. The second electrodes 1516 are electrodes in stripes, which are parallel to one another and extend along a direction intersecting with the first electrodes 1513. Note that, although the EL layer and the conductive layer are also formed over the inversely-tapered partition wall 1522, they are separated from the EL layer 1515 and the second electrode 1516. Note that the EL layer in this embodiment mode has at least a light-emitting layer which includes the phosphor of the present invention. In other words, the EL layer has at least a light-emitting layer including a phosphor having a composite structure in which an emission excitation material is dispersed in a marbled pattern in a phosphor host material. The light-emitting layer may have a structure in which the phosphor is dispersed in a binder. Moreover, the EL layer may have a dielectric layer or a layer which has a function of injecting or transporting electrons or holes, in addition to the light-emitting layer.

The light-emitting device may be a monochromatic light-emitting device which emits light of the same color from an entire surface. Alternatively, by provision of a color conversion layer as appropriate, the light-emitting device may be a light-emitting device which is capable of RGB color (or RGBW color) display, a light-emitting device which is capable of monochromatic color display, or a light-emitting device which is capable of area color display. Here, the EL layer 1515 including the light-emitting layer is separated into a plurality of regions by the partition wall 1514 and the partition wall 1522. Thus, color conversion layers which can convert the color of light into red, green, and blue are arranged in accordance with the separated regions, so that a light-emitting device which performs RGB color display can be obtained. Note that in the case where the EL layer 1515 including a light-emitting layer is formed so as to emit white light, a color conversion layer can be replaced by a color filter. The color conversion layer may be provided between the light-emitting layer and a substrate on the side where light is extracted.

In addition, if necessary, sealing is performed using a sealing material such as a sealing can or a glass substrate for sealing. Here, a glass substrate is used as a second substrate, and the first substrate and the second substrate are attached to each other using an adhesive material such as a sealant, whereby a space surrounded by the adhesive material such as a sealant is sealed off. The sealed space may be filled with filler or a dry inert gas. In addition, a desiccant or the like may be put between the first substrate and the sealing material so that the reliability of the light-emitting device is increased. A small amount of moisture is removed by the desiccant, and thus sufficient drying is performed. As the desiccant, a substance which adsorbs moisture by chemical adsorption, such as an oxide of an alkaline earth metal, such as calcium oxide or barium oxide, can be used. Alternatively, a substance which adsorbs moisture by physical adsorption, such as zeolite or silica gel, can be used as another example of the desiccant.

Note that a desiccant is not necessarily provided in the case where a sealing material which is in contact with the EL element to cover the EL element is provided and the EL element is sufficiently blocked from outside air.

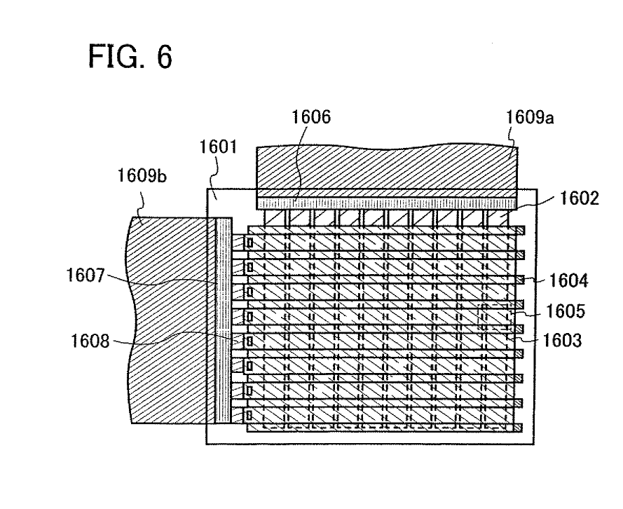

FIG. 6 is a top view of a light-emitting module mounted with an FPC or the like.

Note that the light-emitting device in this specification refers to an image display device, a light-emitting device, or a light source (including a lighting system in its category). In addition, the light-emitting device includes any of the following modules in its category: a module in which a connector such as an flexible printed circuit (FPC), a tape automated bonding (TAB) tape, or a tape carrier package (TCP) is attached to a light-emitting device; a module having a TAB tape or a TCP provided with a printed wiring board at the end thereof; and a module having an integrated circuit (IC) directly mounted on an EL element by a chip on glass (COG) method.

In a pixel portion for displaying images, scan lines and data lines intersect with each other so as to cross at right angles, as shown in FIG. 6.

The first electrodes 1513 in FIGS. 4A to 4C correspond to scan lines 1603 in FIG. 6, the second electrodes 1516 correspond to data lines 1602, and the inversely-tapered partition walls 1522 correspond to partition walls 1604. EL layers each having a light-emitting layer including the phosphor of the present invention are sandwiched between the data lines 1602 and the scan lines 1603, and an intersection indicated by a region 1605 corresponds to one pixel.

Note that the scan lines 1603 are electrically connected, at their ends, to connection wirings 1608, and the connection wirings 1608 are connected to an FPC 1609b through an input terminal 1607. The data lines 1602 are connected to an FPC 1609a through an input terminal 1606.

If necessary, a polarizing plate, a circularly polarizing plate (including an elliptically polarizing plate in its category), a retardation plate (a quarter-wave plate or a half-wave plate), or an optical film such as a color filter may be provided as appropriate over an emission surface. In addition, the polarizing plate or the circularly polarizing plate may be provided with an anti-reflection film. For example, anti-glare treatment may be carried out by which reflected light can be diffused by projections and depressions on the surface so as to reduce reflection.

Through the above-described steps, a passive matrix light-emitting device can be manufactured. The phosphor of the present invention has a composite structure in which an emission excitation material playing a role of generating a local high electric field is dispersed in a marbled pattern so that efficient EL emission with high luminance can be obtained. Emission luminance of an EL element using the phosphor can be increased, and accordingly higher luminance of a light-emitting device provided with the EL element can be obtained. Moreover, the phosphor is manufactured without performing a defect formation step which is difficult to control, and thus variation in quality of individual phosphors is reduced. Thus, the reliability of the light-emitting device can also be improved.

Moreover, the structure of the passive matrix light-emitting device is simple, and thus it can be manufactured easily even when the area is increased. Furthermore, in the case where a dispersion-type EL element is applied as an EL element, a plane emission EL element can be easily and inexpensively manufactured by a screen printing method or the like.

Note that, although the example in which a driver circuit is not provided over the substrate is shown in FIG. 6, the present invention is not particularly limited to the example, and an IC chip including a driver circuit may be mounted on the substrate.

In the case where an IC chip is mounted, a data line side IC and a scan line side IC, in each of which a driver circuit for transmitting each signal to the pixel portion is formed, are mounted on the periphery of (outside) the pixel portion by a COG method. The mounting may be performed using a TCP or a wire bonding method other than the COG method. TCP is a TAB tape mounted with an IC, and the TAB tape is connected to a wiring over an element formation substrate to mount the IC. Each of the IC connected to the data line and the IC connected to the scan line may be formed using a silicon substrate. Alternatively, the IC may be a driver circuit which is formed using TFTs over a glass substrate, a quartz substrate, or a plastic substrate. Although described here is an example in which a single IC is provided on one side, a plurality of divided ICs may be provided on one side.

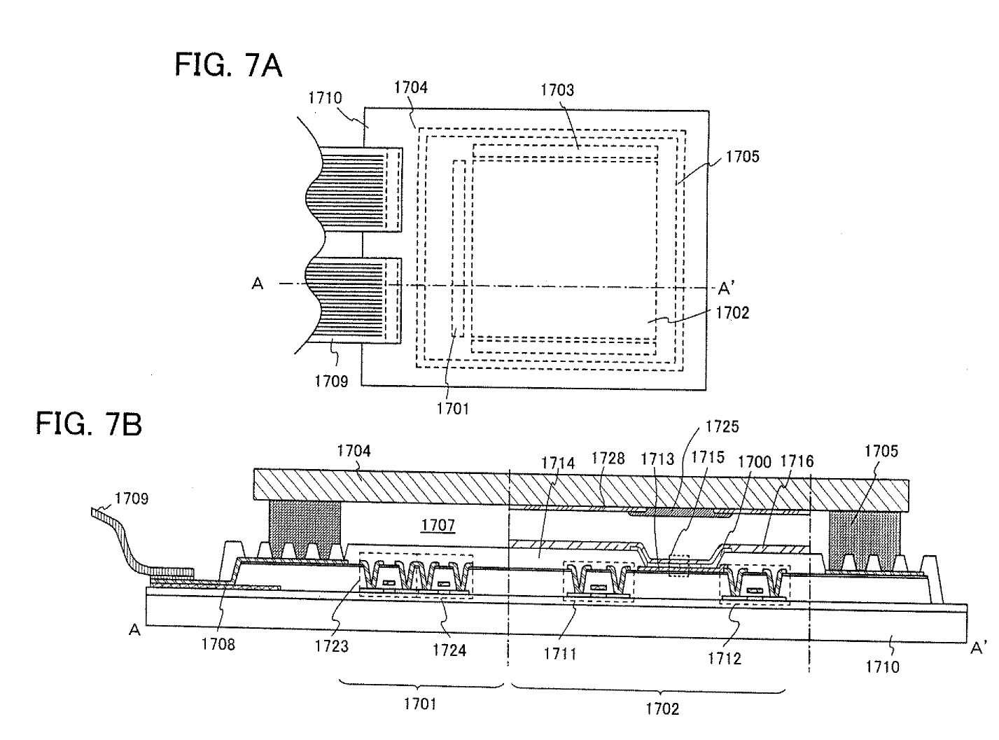

Next, an example of an active matrix light-emitting device is shown in FIGS. 7A and 7B. Note that FIG. 7A is a top view showing a light-emitting device and FIG. 7B is a cross-sectional view taken along the line segment A-A′ in FIG. 7A. The active matrix light-emitting device of this embodiment mode includes a pixel portion 1702 provided over an element substrate 1710, a driver circuit portion (a source side driver circuit) 1701, and a driver circuit portion (a gate side driver circuit) 1703. The pixel portion 1702, the driver circuit portion 1701, and the driver circuit portion 1703 are sealed, with a sealant 1705, between the element substrate 1710 and a sealing substrate 1704.

In addition, over the element substrate 1710, a lead wiring 1708 for connecting an external input terminal which transmits a signal (e.g., a video signal, a clock signal, a start signal, or a reset signal) or an electric potential to the driver circuit portion 1701 and the driver circuit portion 1703 is provided. In this embodiment mode, an example in which a flexible printed circuit (FPC) 1709 is provided as the external input terminal is shown. Note that, although only the FPC is shown in the drawing in this embodiment mode, the FPC may be provided with a printed wiring board (PWB). The light-emitting device in this specification includes, in its category, not only a main body of a light-emitting device but also a light-emitting device with an FPC or a PWB attached thereto.

Next, the cross-sectional structure will be described with reference to FIG. 7B. Although the driver circuit portions and the pixel portion are formed over the element substrate 1710, in FIG. 7B, the pixel portion 1702 and the driver circuit portion 1701 which is the source side driver circuit are shown.

An example is shown in which a CMOS circuit which is the combination of an n-channel TFT 1723 and a p-channel TFT 1724 is formed as the driver circuit portion 1701. Note that a circuit included in the driver circuit portion may be a known CMOS circuit, PMOS circuit, or NMOS circuit. Although a driver-integrated type where the driver circuit is formed over the substrate is described in this embodiment mode, the present invention is not limited to this structure, and the driver circuit may be formed outside the substrate, not over the substrate.

The pixel portion 1702 includes a plurality of pixels, each of which includes a switching TFT 1711, a current-controlling TFT 1712, and a first electrode 1713 which is electrically connected to a wiring (a source electrode or a drain electrode) of the current-controlling TFT 1712. Note that a partition wall 1714 is formed so as to cover the end portions of the first electrode 1713. In this embodiment mode, the partition wall 1714 is formed using a positive photosensitive acrylic resin.

The partition wall 1714 is preferably formed so as to have a curved surface with curvature at an upper end portion or a lower end portion thereof in order to obtain favorable coverage by a film which is to be stacked over the partition wall 1714. For example, in the case of using a positive photosensitive acrylic resin as a material for the partition wall 1714, the partition wall 1714 is preferably formed so as to have a curved surface with a curvature radius (0.2 μm to 3 μm) at the upper end portion thereof. Either a negative photosensitive material which becomes insoluble in an etchant by light irradiation or a positive photosensitive material which becomes soluble in an etchant by light irradiation can be used for the partition wall 1714. As the partition wall 1714, without limitation to an organic compound, both an organic compound and an inorganic compound such as silicon oxide or silicon oxynitride can be used.

An EL layer 1700 including a light-emitting layer and a second electrode 1716 are stacked over the first electrode 1713, Note that when the first electrode 1713 is formed using ITO, and a stacked film of a titanium nitride film and a film containing aluminum as its main component or a stacked film of a titanium nitride film, a film containing aluminum as its main component, and a titanium nitride film is used as a wiring of the current-controlling TFT 1712 which is connected to the first electrode 1713, the resistance of the wiring is low and favorable ohmic contact with the electrode formed using ITO can be obtained. Note that, although not shown in FIGS. 7A and 7B, the second electrode 1716 is electrically connected to the FPC 1709 which is an external input terminal.

The EL layer 1700 is provided with at least a light-emitting layer which includes the phosphor of the present invention. In other words, the EL layer 1700 is provided with at least the layer which includes the phosphor having a composite structure in which an emission excitation material is dispersed in a marbled pattern in a phosphor host material. The light-emitting layer may have a structure in which the phosphor is dispersed in a binder. The EL layer 1700 may also be provided with a dielectric layer or a layer having a function of injecting or transporting electrons or holes, in addition to the light-emitting layer. An EL element 1715 is formed as a stacked structure including the first electrode 1713, the EL layer 1700, and the second electrode 1716.

Although only one EL element 1715 is shown in the cross-sectional view of FIG. 7B, a plurality of EL elements are arranged in matrix in the pixel portion 1702. The plurality of EL elements 1715 can be selectively formed while being separated from one another.

Furthermore, the sealing substrate 1704 and the element substrate 1710 are attached to each other with the sealant 1705, whereby the EL element 1715 is provided in a space 1707 surrounded by the element substrate 1710, the sealing substrate 1704, and the sealant 1705. Note that the space 1707 may be filled with the sealant 1705 as well as an inert gas (e.g., nitrogen or argon).

Note that an epoxy resin is preferably used as the sealant 1705. In addition, such a material is desirably a material which does not transmit moisture or oxygen as much as possible. As a material used for the sealing substrate 1704, a plastic substrate made of fiberglass-reinforced plastics (FRP), polyvinyl fluoride (PVF), polyester, acrylic, or the like can be used as well as a glass substrate or a quartz substrate.

The light-emitting device may be a light-emitting device which emits light of the same color from an entire surface. However, for example, as shown in FIG. 7B, a light conversion layer 1725 and a light-shielding layer 1728 are provided on the sealing substrate 1704 side, so that a light-emitting device which is capable of RGB color (or RGBW color) display, a light-emitting device which is capable of monochromatic color display, or a light-emitting device which is capable of area color display can be manufactured. For example, color conversion layers which convert the color of light into red, green, and blue are arranged as the color conversion layers 1725, in accordance with the divided EL elements 1715, so that a light-emitting device which performs RGB color display can be manufactured. Note that in the case where the EL element 1715 is formed so as to emit white light, a color conversion layer can be replaced by a color filter.

Through the above-described steps, an active matrix light-emitting device can be manufactured. The phosphor of the present invention has a composite structure in which an emission excitation material playing a role of generating a local high electric field are dispersed in a marbled pattern so that efficient EL emission with high luminance can be obtained. Emission luminance of an EL element using the phosphor can be increased, and accordingly higher luminance of a light-emitting device provided with the EL element can be obtained. Moreover, the phosphor is manufactured without performing a defect formation step which is difficult to control, and thus variation in quality of individual phosphors is reduced. Thus, the reliability of the light-emitting device can be improved.

Note that this embodiment mode can be combined with other embodiment modes and embodiments in this specification as appropriate.

### Embodiment Mode 4

Higher luminance of the light-emitting device described in Embodiment Mode 3 can be obtained by use of the phosphor of the present invention. Therefore, the light-emitting device using the phosphor is incorporated as various display devices or a display portion of electronic devices, whereby bright display can be performed. Moreover, the phosphor of the present invention can be manufactured without a defect formation step which is difficult to control, and thus phosphors with little variation in quality can be provided. Therefore, the reliability of the light-emitting device can be increased.

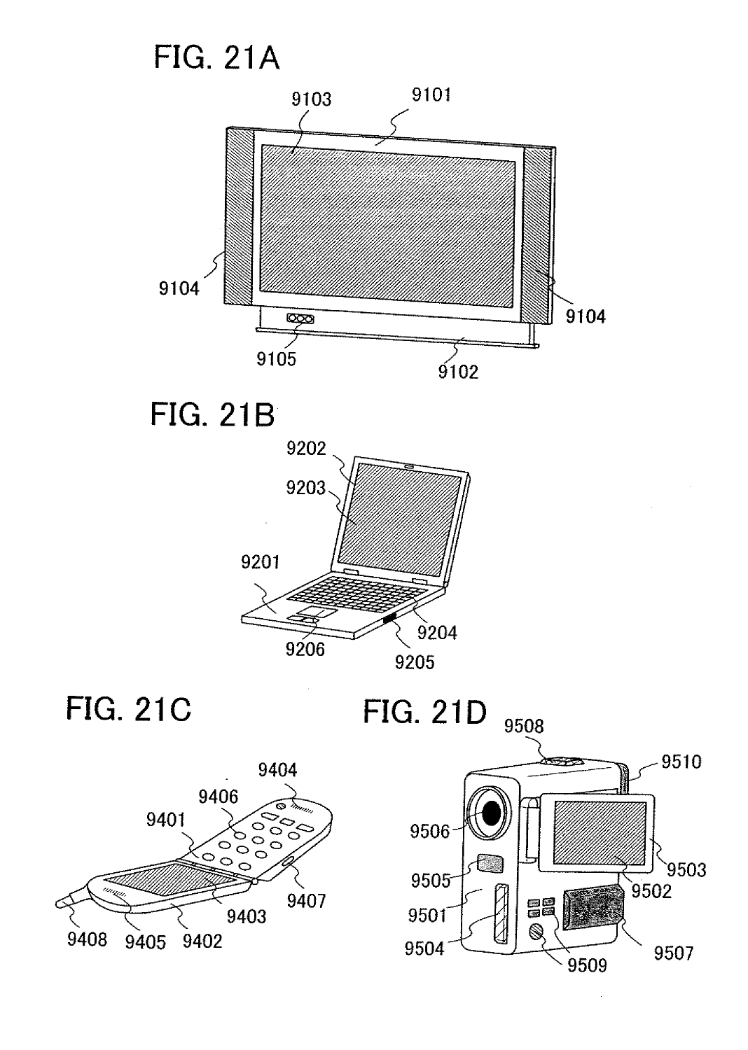

The light-emitting, device using the phosphor of the present invention can be applied to a display portion of an electronic device or a display device with a large screen. For example, the following can be given: cameras such as video cameras or digital cameras, goggle type displays, navigation systems, audio reproducing devices (e.g., car audio components and audio components), computers, game machines, portable information terminals (e.g., mobile computers, cellular phones, portable game machines, and electronic books), and image reproducing devices provided with recording media (specifically, the devices which can reproduce a recording medium such as a digital versatile disc (DVD) and is provided with a display device which is capable of displaying the reproduced images), and the like. Specific examples of these electronic devices are shown in FIGS. 21A to 21D.

FIG. 21A shows an example of a television set, which includes a housing 9101, a supporting base 9102, a display portion 9103, a speaker portion 9104, video input terminals 9105, and the like. In the television set, for example, a light-emitting device using the phosphor of the present invention can be used in the display portion 9103. The light-emitting device using the phosphor of the present invention has higher luminance, and thus the television set can display bright and clear images.

FIG. 21B shows an example of a computer, which includes a main body 9201, a housing 9202, a display portion 9203, a keyboard 9204, an external connection port 9205, a pointing device 9206, and the like. In the computer, for example, a light-emitting device using the phosphor of the present invention can be used in the display portion 9203. The light-emitting device using the phosphor of the present invention has higher luminance, and thus the computer can display bright and clear images.

FIG. 21C shows an example of a cellular phone, which includes a main body 9401, a housing 9402, a display portion 9403, an audio input portion 9404, an audio output portion 9405, operation keys 9406, an external connection port 9407, an antenna 9408, and the like. In the cellular phone, for example, a light-emitting device using the phosphor of the present invention can be used in the display portion 9403. The light-emitting device using the phosphor of the present invention has higher luminance, and thus the cellular phone can display bright aid clear images.

FIG. 21D shows an example of a camera, which includes a main body 9501, a display portion 9502, a housing 9503, an external connection port 9504, a remote control receiver 9505, an image receiver 9506, a buttery 9507, an audio input portion 9508, operation keys 9509, an eyepiece portion 9510 and the like. In the camera, for example, a light-emitting device using a phosphor of the present invention can be used in the display portion 9502. The light-emitting device using the phosphor of the present invention has higher luminance, and thus the camera can display bright and clear images.

As described above, the applicable range of the light-emitting device of the present invention is so wide that the light-emitting device can be applied to electronic devices in a variety of fields. The use of the light-emitting device using the phosphor of the present invention makes it possible to provide an electronic device including a display portion which can display bright images.

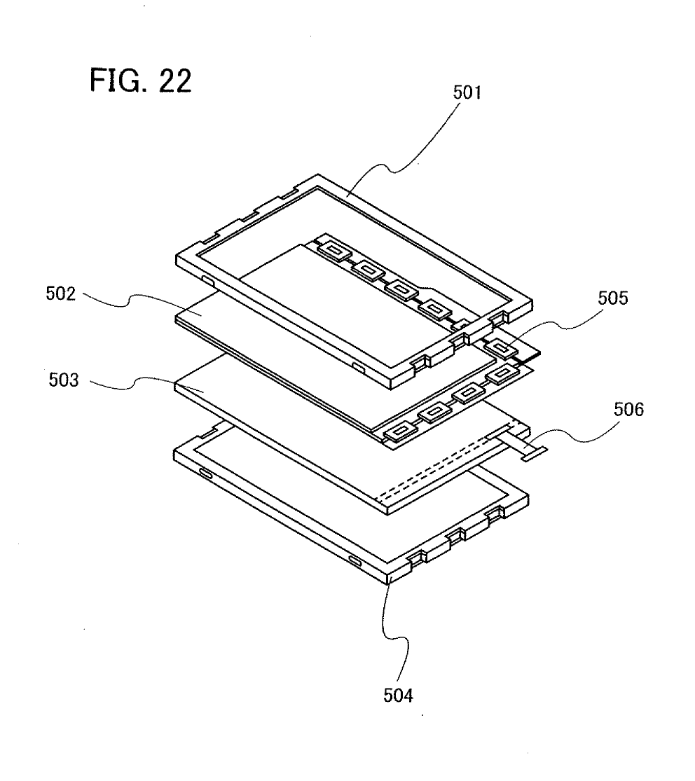

Moreover, the light-emitting device using the phosphor of the present invention has an EL element with high emission luminance and can also be used as a lighting device or a light source. FIG. 22 shows an example in which the light-emitting device using the phosphor of the present invention is used as a light source.

FIG. 22 shows an example of a liquid crystal display device which uses, as a backlight, the light-emitting device using the phosphor of the present invention. The liquid crystal display device shown in FIG. 22 includes a housing 501, a liquid crystal layer 502, a backlight 503, and a housing 504. The liquid crystal layer 502 is connected to a driver IC 505. The light-emitting device using the phosphor of the present invention is used as the backlight 503, to which current is supplied through a terminal 506.

The light-emitting device of the present invention can be used as a backlight of a liquid crystal display device, whereby a bright backlight can be obtained.

### Embodiment 1

Hereinafter, a phosphor and an EL element of the present invention will be described based on embodiments.

24.184 g of ZnS:Mn powder as a phosphor host material and 5.816 g of ZnO powder as an emission excitation material were each weighed. The ZnS:Mn is a material in which ZnS (24.080 g) has been activated in advance with Mn (0.104 mg) which is an activator.

The ZnS:Mn powder and the ZnO powder each of which had been weighed were put in a planetary pot mill together with 90 g of balls with φ 2 mm made of ZrO. Then, they were mixed and smashed by a wet process at a rotation number of 300 rpm for 60 minutes. The materials were mixed and smashed by rotation of the balls made of ZrO in the planetary pot mill.

The obtained mixture was dried and sifted with a sieve having openings of 1 mm, so that the balls made of ZrO were separated from the mixture. Then, the mixture obtained after being sifted was baked with pressure by a hot pressing method for 60 minutes under conditions where the welding pressure was 40 MPa and the baking temperature was 950° C. under an Ar atmosphere. At this time, the mixture was shaped into pellets.

The obtained baked pellets were smashed with use of a mortar, and then they were classified through a sieve having openings of 50 μm, so that phosphor powder was obtained.

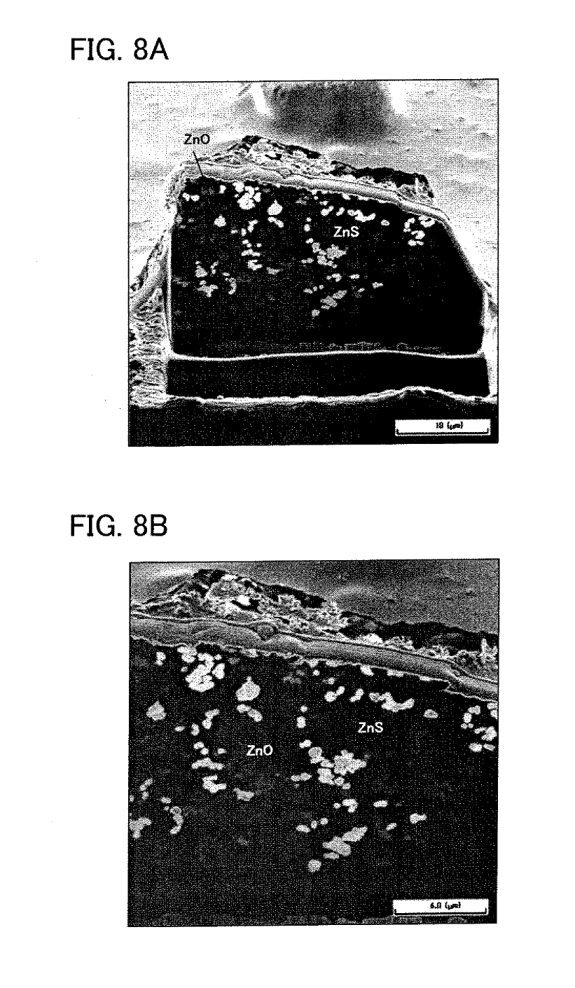

One phosphor particle of the obtained phosphor powder was processed with a focused ion beam system (FIB) so that the cross section of the particle can be observed A SIM image of the cross section of the particle is shown in FIG. 8A, and a partially-enlarged image of the image of FIG. 8A is shown in FIG. 8B. Note that it was confirmed, by a STEM-EDX, that in SIM images hereinafter shown, a white region corresponds to ZnO and a black region corresponds to ZnS. Thus, according to FIGS. 8A and 8B, it was confirmed that a composite structure was formed in which ZnO was dispersed in a marbled pattern in ZnS.

As described above, the phosphor of the present invention was manufactured through the steps in which the phosphor host material to which the activator had been added and the emission excitation material were mixed, and then the mixture was baked with pressure. The manufacturing method of the phosphor of the present invention does not include a defect formation step in which crystal defects are formed inside the phosphor by application of stress from the outside of the phosphor, or the like.

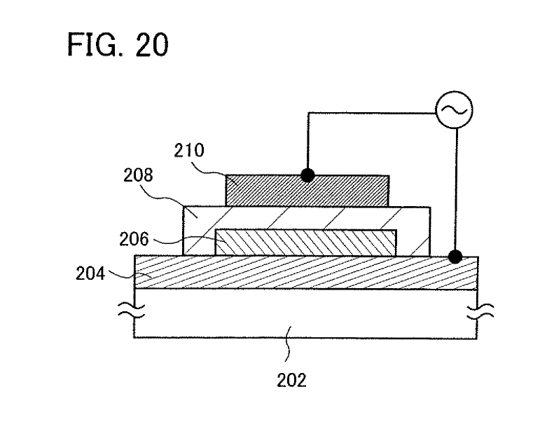

An EL element was manufactured using the above-described phosphor. The EL element will be described below with reference to FIG. 20.

First, an ITO film was formed to a thickness of 110 nm over a glass substrate 202 by a sputtering method so that a first electrode 204 was formed.

Next, the phosphor powder manufactured as described above was dispersed in a N,N-dimethylformamide (DMF) solution as a solvent, in which cyanoresin had been dissolved; thus, a dispersion solution was made. The above-described dispersion solution was applied onto the first electrode 204, and then it was dried at 120° C. for 30 minutes, so that a light-emitting layer 206 was formed. Note that the above-described dispersion solution was made in such a manner that 0.100 g of the above-described phosphor powder was added to 0.070 g of DMF and 0.033 g of cyanoresin. In addition, the light-emitting layer 206 was formed to a thickness of about 50 μm.

Next, a dispersion solution in which barium titanate had been dispersed in DMF as a solvent, in which cyanoresin had been dissolved, was applied onto the light-emitting layer 206, and then it was dried at 120° C. for 60 minutes, so that a dielectric layer 208 was formed. Note that the above-described dispersion solution was made in such a manner that 3.000 g of barium titanate was added to 1.800 g of DMF and 1.000 g of cyanoresin. In addition, the dielectric layer 208 was formed to a thickness of about 15 μm.

Ag paste was applied onto the dielectric layer 208, and then it was dried at 120° C. for 60 minutes, so that a second electrode 210 was formed.

Through the above-described steps, an EL element including the light-emitting layer 206 and the dielectric layer 208 between the first electrode 204 and the second electrode 210 was obtained. The EL element is an example of a dispersion-type EL element. The phosphor of the present invention is dispersed in the light-emitting layer 206.

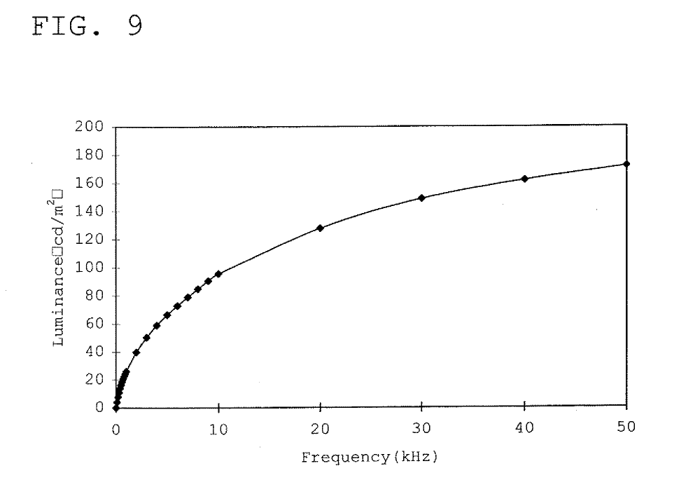

When a sine wave AC voltage of 400 V at a frequency of 50 kHz was applied to the manufactured EL element so that the EL element emits light, an EL emission luminance of about 171.9 cd/m² was obtained. Specifically, the characteristics in which the EL emission luminance increased from 0 cd/m² to about 171.9 cd/m² nonlinearly in the frequency range of 0 Hz to 50 kHz were obtained (see FIG. 9).

### Embodiment 2

In this embodiment, an example in which the phosphor obtained in Embodiment 1 was washed with an acid solution will be described.

The phosphor powder obtained in Embodiment 1 was washed with an acetic acid aqueous solution (1.74 mol %) for 10 minutes. Then, the phosphor powder washed with the above-described acetic acid aqueous solution was washed with pure water. The phosphor powder was washed until the solution used for the washing became neutral, and then the powder was dried.

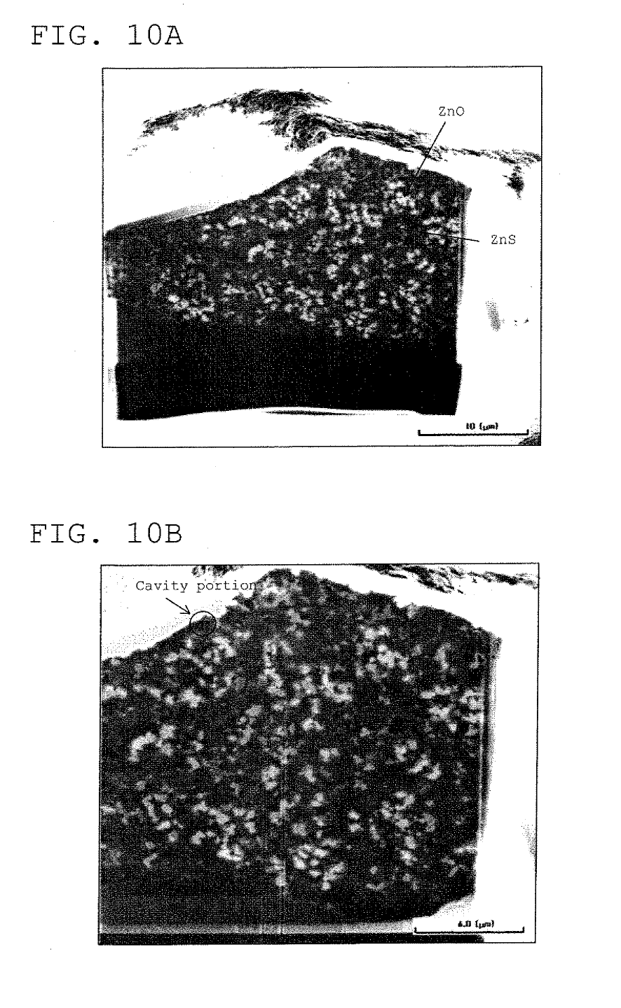

One phosphor particle of the dried phosphor powder was thinned with an FIB so that the cross section of the particle can be observed. A SIM image of the cross section of the particle is shown in FIG. 10A, and a partially-enlarged image of the image of FIG. 10A is shown in FIG. 10B. According to FIGS. 10A and 10B, it was confirmed that a composite structure was formed in which ZnO was dispersed in a marbled pattern in ZnS. Moreover, a cavity was confirmed near a surface of the phosphor particle. The cavity was observed as a black region darker than the black region corresponding to ZnS. It is estimated that the cavity observed here was formed by etching of ZnO due to the washing with the acetic acid aqueous solution.

An EL element was manufactured using the above-described phosphor powder. Specifically, a dispersion-type EL element was manufactured in a similar manner to the EL element of FIG. 20 in Embodiment 1. The phosphor obtained in Embodiment 2 was dispersed in the light-emitting layer 206, and the element structure and the manufacturing method are similar to those in Embodiment 1, and thus the description is omitted here.

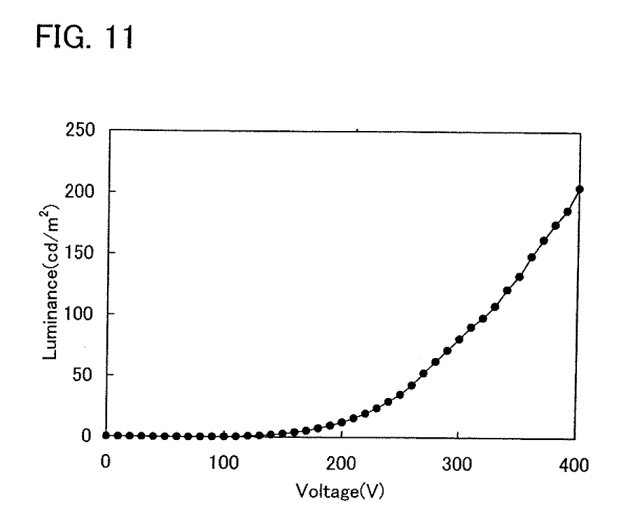

When a sine wave AC voltage of 400 V at a frequency of 50 kHz was applied to the manufactured EL element so that the EL element emits light, an EL emission luminance of about 204.7 cd/m² was obtained. Specifically, the characteristics in which the EL emission luminance increased from 0 cd/m² to about 204.7 cd/m² nonlinearly in the voltage range of 0 V to 400 V were obtained (see FIG. 11).

Accordingly, it was confirmed that the EL emission luminance of the phosphor used in the light-emitting layer of the EL element could be increased by removal of the emission excitation material at a surface of the phosphor by washing after baking the phosphor with pressure.

### Embodiment 3

In this embodiment, an example of using Ag as an activator will be described.

24.184 g of ZnS:Ag powder as a phosphor host material and 5.816 g of ZnO powder as an emission excitation material were each weighed. The ZnS:Ag is a material in which ZnS has been activated in advance with Ag (manufactured by Kasei Optonix, Ltd.) which is an activator, he manufacturing method of the phosphor other than the raw materials is the same as that in Embodiment 1, and thus the description is omitted.

An EL element was manufactured using phosphor powder obtained through mixture, baking with pressure, smashing, classification, and the like. As for the EL element, a dispersion-type EL element was manufactured in a similar manner to the EL element of FIG. 20 in Embodiment 1, and the phosphor powder obtained in Embodiment 3 was dispersed in the light-emitting layer 206.

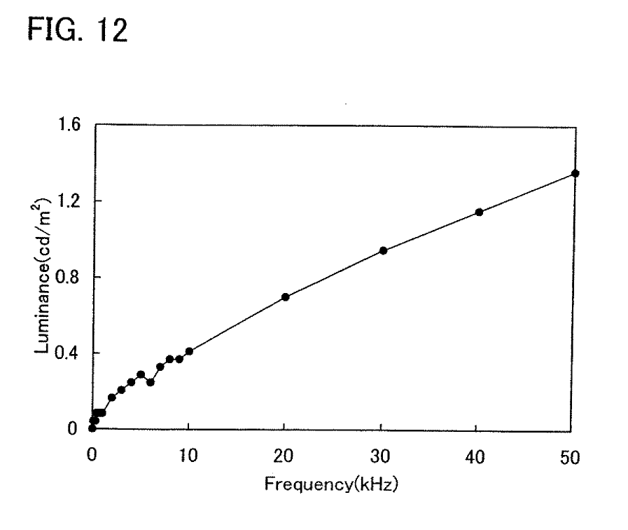

When a sine wave AC voltage of 400 V at a frequency of 50 kHz was applied to the manufactured EL element so that the EL element emits light, an EL emission luminance of about 1.4 cd/m² was obtained. Specifically, the characteristics in which the EL emission luminance increased from 0 cd/m² to about 1.4 cd/m² nonlinearly in the frequency range of 0 Hz to 50 kHz were obtained (see FIG. 12).

### Embodiment 4

In this embodiment, an example of using CuCl as an activator will be described.

24.184 g of ZnS:CuCl powder as a phosphor host material and 5.816 g of ZnO powder as an emission excitation material were each weighed. The ZnS:CuCl is a material in which ZnS has been activated in advance with CuCl (manufactured by Sylvania Inc.) which is an activator. The manufacturing method of the phosphor other than the raw materials is the same as that in Embodiment 1, and thus the description is omitted.

An EL element was manufactured using phosphor powder obtained through mixture, baking with pressure, smashing, classification, and the like. As for the EL element, a dispersion-type EL element was manufactured in a similar manner to the EL element of FIG. 20 in Embodiment 1, and the phosphor obtained in Embodiment 4 was dispersed in the light-emitting layer 206.

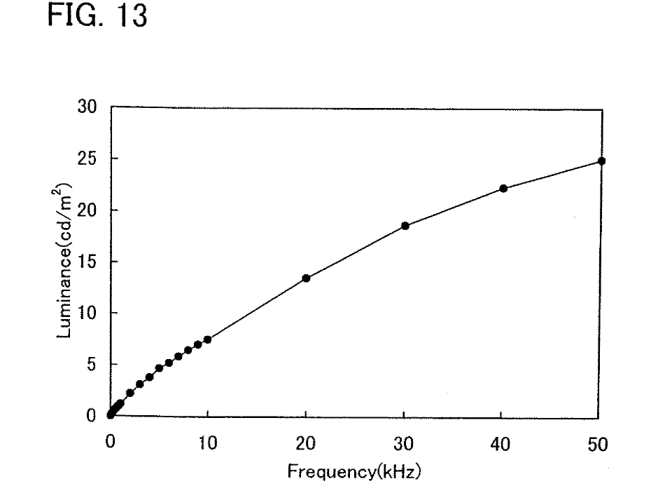

When a sine wave AC voltage of 400 V at a frequency of 50 kHz was applied to the manufactured EL element so that the EL element emits light, an EL emission luminance of about 25.1 cd/m² was obtained. Specifically, the characteristics in which the EL emission luminance increased from 0 cd/m² to about 25.1 cd/m² nonlinearly in the frequency range of 0H to 50 kHz were obtained (see FIG. 13).

### Embodiment 5

In this embodiment, an example using In₂O₃ as an emission excitation material will be described.

22.981 g of ZnS:Mn powder as a phosphor host material and 7.019 g of In₂O₃ powder as an emission excitation material were each weighed. The manufacturing method of the phosphor other than the raw materials is the same as that in Embodiment 1, and thus the description is omitted.

An EL element was manufactured using phosphor powder obtained through mixture, baking with pressure, smashing, classification, and the like. As for the EL element, a dispersion-type EL element was manufactured in a similar manner to the EL element of FIG. 20 in Embodiment 1, and the phosphor obtained in Embodiment 5 was dispersed in the light-emitting layer 206.

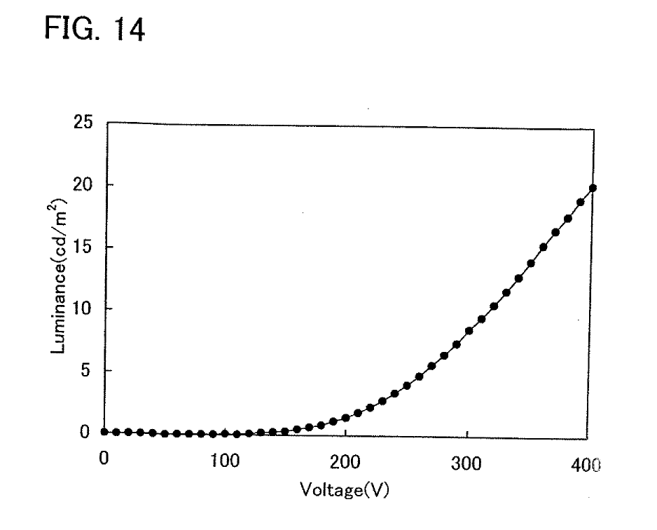

When a sine wave AC voltage of 400 V at a frequency of 50 kHz was applied to the manufactured EL element so that the EL element emits light, an EL emission luminance of about 20.3 cd/m² was obtained. Specifically, the characteristics in which the EL emission luminance increased from 0 cd/m² to about 20.3 cd/m² nonlinearly in the voltage range of 0 V to 400 V were obtained (see FIG. 14).

### Embodiment 6

In this embodiment, an example of manufacturing a phosphor at a temperature of baking with pressure which is different from the temperature in the above embodiments will be described.

24.184 g of ZnS:Mn powder as a phosphor host material and 5.816 g of ZnO powder were each weighed. Then, in a similar manner to Embodiment 1, the ZnS:Mn powder and the ZnO powder were put in a planetary pot mill together with balls made of ZrO to be mixed and smashed by a wet process. The mixture and smashing were performed at a rotation number of 300 rpm for 60 minutes.

The obtained mixture was dried and sifted with a sieve having openings of 1 mm, so that the balls made of ZrO were separated from the mixture. Then, the mixture obtained after being sifted was baked with pressure by a hot pressing method for 60 minutes under conditions where the welding pressure was 40 MPa and the baking temperature was 1150° C. under an Ar atmosphere. At this time, the mixture was shaped into pellets.

In a similar manner to Embodiment 1, the obtained baked pellets were smashed and then sifted with a sieve having openings of 50 μm to be classified. An EL element was manufactured using the obtained phosphor powder. As for the EL element, a dispersion-type EL element was manufactured in a similar manner to the EL element of FIG. 20 in Embodiment 1, and the phosphor obtained in Embodiment 6 was dispersed in the light-emitting layer 206.

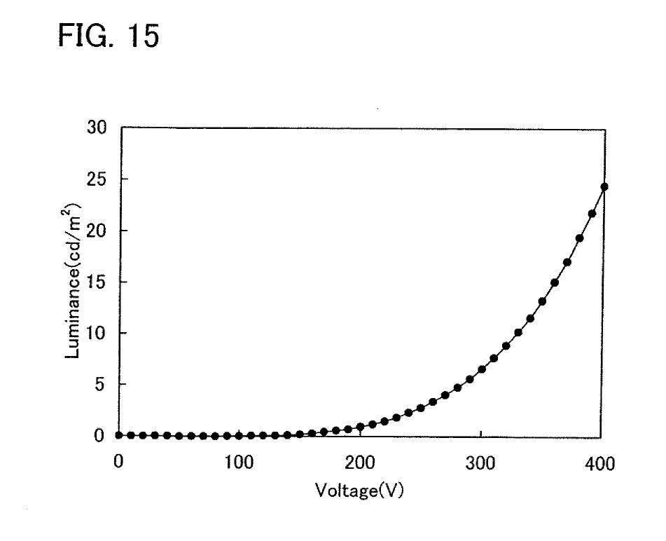

When a sine wave AC voltage of 400 V at a frequency of 50 kHz was applied to the manufactured EL element so that the EL element emits light, an EL emission luminance of about 24.5 cd/m² was obtained. Specifically, the characteristics in which the EL emission luminance increased from 0 cd/m² to about 24.5 cd/m² nonlinearly in the voltage range of 0 V to 400 V were obtained (see FIG. 15).

### Embodiment 7

In this embodiment, an example of using ZnMnO as an emission excitation material will be described.

First, 14.342 g of ZnO powder and 0.658 g of MnO powder were each weighed. Then, they were put in a planetary pot mill together with 90 g of balls with φ 2 mm made of ZrO, and they were mixed and smashed by a wet process at a rotation number of 300 rpm for 60 minutes.

The obtained mixture was dried and sifted with a sieve having openings of 1 mm, so that the balls made of ZrO were separated from the mixture. Then, the mixture obtained after being sifted was baked at a baking temperature of 1150° C. for 180 minutes under a nitrogen atmosphere, so that ZnMnO which was a solid solution of manganese zinc oxide was obtained. ZnMnO obtained here was used as an emission excitation material.

24.184 g of ZnS:Mn powder as a phosphor host material and 5.816 g of ZnMnO powder as an emission excitation material were each weighed. Then, they were put in a planetary pot mill together with 90 g of balls with φ 2 mm made of ZrO as described above, and they were mixed and smashed by a wet process at a rotation number of 300 rpm for 60 minutes.

The obtained mixture was dried and sifted with a sieve having openings of 1 mm, so that the balls made of ZrO were separated from the mixture. Then, the mixture obtained after being sifted was baked with pressure by a hot pressing method for 60 minutes under conditions where the welding pressure was 40 MPa and the baking temperature was 1150° C. under an Ar atmosphere. At this time, the mixture was shaped into pellets.

In a similar manner to Embodiment 1, the obtained baked pellets were smashed and then sifted with a sieve having openings of 50 μm to be classified. An EL element was manufactured using the obtained phosphor powder. As for the EL element, a dispersion-type EL element was manufactured in a similar manner to the EL element of FIG. 20 in Embodiment 1, and the phosphor obtained in Embodiment 7 was dispersed in the light-emitting layer 206.

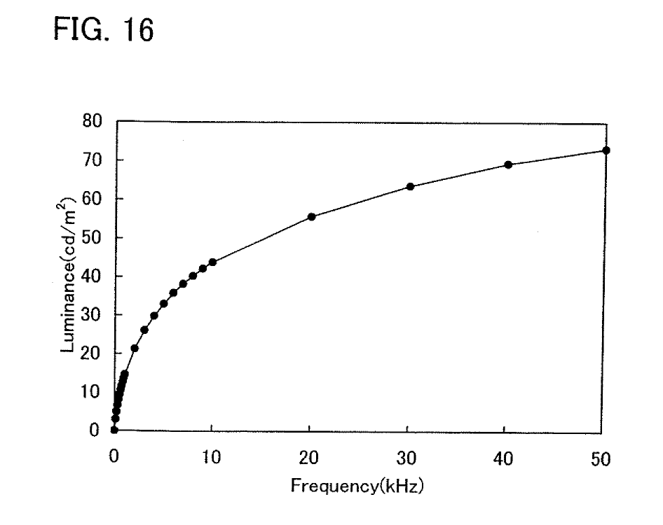

When a sine wave AC voltage of 400 V at a frequency of 50 kHz was applied to the manufactured EL element so that the EL element emits light, an EL emission luminance of about 73.3 cd/m² was obtained. Specifically, the characteristics in which the EL emission luminance increased from 0 cd/m² to about 73.3 cd/m² nonlinearly in the frequency range of 0 Hz to 50 kHz were obtained (see FIG. 16).

### Embodiment 8

In this embodiment, an example will be described in which a phosphor host material and an emission excitation material were mixed at a proportion different from that in Embodiment 1.

16.346 g of ZnS:Mn powder as a phosphor host material and 13.654 g of ZnO powder as an emission excitation material were each weighed. The manufacturing method of the phosphor other than the amount of the ZnS:Mn powder and the ZnO powder, which serve as raw materials, is similar to that in Embodiment 1, and thus the description is omitted.

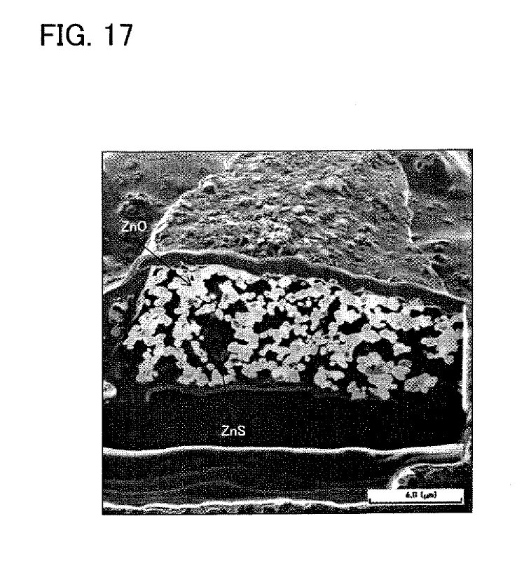

One phosphor particle of the phosphor powder obtained through mixture, baking with pressurization, smashing, classification, and the like was thinned with an FIB so that a cross section of the particle can be observed. A SIM image of the cross section of the particle is shown in FIG. 17. According to FIG. 17, it was confirmed that a composite phosphor was formed in which ZnO was dispersed in a marbled pattern in ZnS.

An EL element was manufactured using the above-described phosphor powder. As for the EL element, a dispersion-type EL element was manufactured in a similar manner to the EL element of FIG. 20 in Embodiment 1, and the phosphor obtained in Embodiment 8 was dispersed in the light-emitting layer 206.

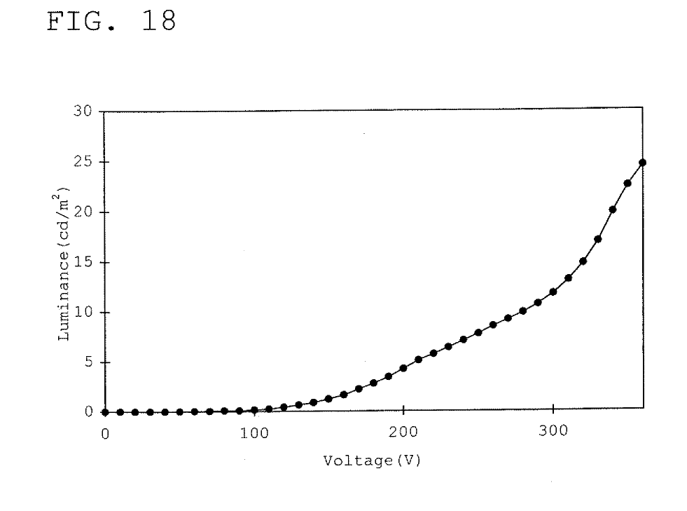

When a sine wave AC voltage of 360 V at a frequency of 50 kHz was applied to the manufactured EL element so that the EL element emits light, an EL emission luminance of about 25 cd/m² was obtained. Specifically, the characteristics in which the EL emission luminance increased from 0 cd/m² to about 25 cd/m² nonlinearly in the voltage range of 0 V to 360 V were obtained (see FIG. 18).

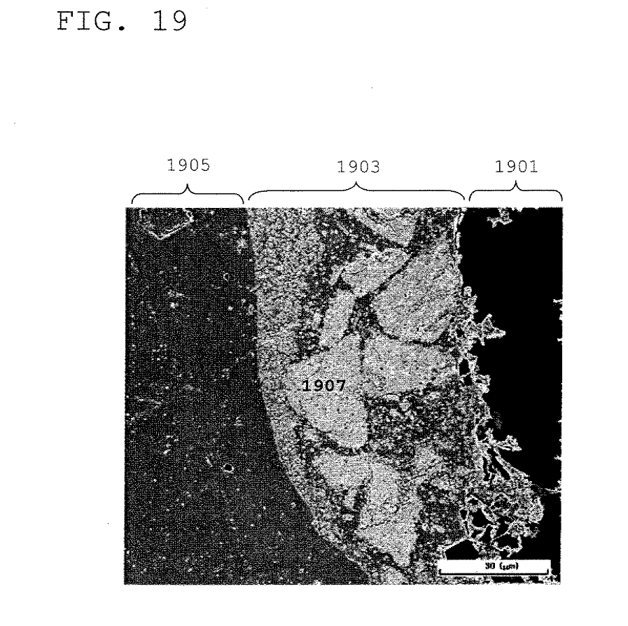

Moreover, the manufactured EL element was thinned with an FIB so that the cross section of the element could be observed. A SIM image of the cross section of the element is shown in FIG. 19. In FIG. 19, a structure is shown in which a glass substrate 1901, a light-emitting layer 1903, and barium titanate 1905 which is a dielectric layer are sequentially stacked. Note that, although an ITO electrode is formed between the glass substrate and the light-emitting layer, the ITO electrode cannot be found because it is as thin as 110 nm. According to FIG. 19, it was confirmed that phosphor particles 1907 were dispersed in the light-emitting layer.

This application is based on Japanese Patent Application serial no. 2007-225301 filed with Japan Patent Office on Aug. 31, 2007, the entire contents of which are hereby incorporated by reference.

What is claimed is:

1. A phosphor comprising:
a phosphor host material; and
an emission excitation material which is dispersed in a marbled pattern in the phosphor host material and is separated from the phosphor host material,
wherein the emission excitation material is a material selected from a group consisting of a metal oxide, a semiconductor formed of an element belonging to Group 2B (Group 12) of the periodic table and an element belonging to Group 6B (Group 16) of the periodic table, and a semiconductor formed of an element belonging to Group 3B (Group 13) of the periodic table and an element belonging to Group 5B (Group 15) of the periodic table.

2. The phosphor according to claim 1, wherein the emission excitation material is formed of emission excitation material particles whose average central grain sizes are each smaller than a particle including the phosphor host material and the emission excitation material.

3. The phosphor according to claim 2, wherein one of the emission excitation material particles is connected in series to another emission excitation material particle.

4. The phosphor according to claim 1, wherein the metal oxide is any one of zinc oxide, nickel oxide, tin oxide, titanium oxide, cobalt trioxide, cobalt oxide, tungsten oxide, molybdenum oxide, vanadium trioxide, vanadium pentoxide; indium tin oxide, indium oxide, rhenium trioxide, ruthenium oxide, strontium ruthenium oxide, strontium iridium oxide, or barium lead oxide.

5. The phosphor according to claim 1, wherein the semiconductor formed of an element belonging to Group 2B (Group 0.12) of the periodic table and an element belonging to Group 6B (Group 16) of the periodic table is zinc oxide.

6. The phosphor according to claim 1, wherein the semiconductor formed of an element belonging to Group 3B (Group 13) of the periodic table and an element belonging to Group 5B (Group 15) of the periodic table is indium phosphide.

7. The phosphor according to claim 1, wherein the phosphor host material is a material in which the emission excitation material is not mixed to form a solid solution.

8. A phosphor comprising:
a phosphor host material; and
an emission excitation material which is dispersed in a marbled pattern in the phosphor host material and is separated from the phosphor host material,
wherein the emission excitation material is a material selected from a group consisting of a metal oxide, a semiconductor formed of an element belonging to Group 2B (Group 12) of the periodic table and an element belonging to Group 6B (Group 16) of the periodic table, and a semiconductor formed of an element belonging to Group 3B (Group 13) of the periodic table and an element belonging to Group 5B (Group 15) of the periodic table, and
wherein a surface of the phosphor is formed of the phosphor host material.

9. The phosphor according to claim 8, wherein the emission excitation material is formed of emission excitation material particles whose average central grain sizes are each smaller than a particle including the phosphor host material and the emission excitation material.

10. The phosphor according to claim 9, wherein one of the emission excitation material particles is separated from another emission excitation material particle.

11. The phosphor according to claim 8, wherein the metal oxide is any one of zinc oxide, nickel oxide, tin oxide, titanium oxide, cobalt trioxide, cobalt oxide, tungsten oxide, molybdenum oxide, vanadium trioxide, vanadium pentoxide; indium tin oxide, indium oxide, rhenium trioxide, ruthenium oxide, strontium ruthenium oxide, strontium iridium oxide, or barium lead oxide.

12. The phosphor according to claim 8, wherein the semiconductor formed of an element belonging to Group 2B (Group 12) of the periodic table and an element belonging to Group 6B (Group 16) of the periodic table is zinc oxide.

13. The phosphor according to claim 8, wherein the semiconductor formed of an element belonging to Group 3B (Group 13) of the periodic table and an element belonging to Group 5B (Group 15) of the periodic table is indium phosphide.

14. The phosphor according to claim 8, wherein the phosphor host material is a material in which the emission excitation material is not mixed to form a solid solution.

15. A method for manufacturing a phosphor, comprising the steps of:
mixing a phosphor host material and an emission excitation material formed of a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table, as raw materials; and
baking an obtained mixture with pressure.

16. The method for manufacturing a phosphor, according to claim 15, wherein the baking with pressure is performed by a hot pressing method, a hot isostatic pressing method, a discharge plasma sintering method, or an impact method.

17. The method for manufacturing a phosphor, according to claim 15, wherein the raw materials are mixed by a wet process and an obtained mixed material is smashed so that a grain size of the obtained mixed material thereof becomes small.

18. The method for manufacturing a phosphor, according to claim 15, wherein the baking is performed at a pressure of about 20 Pa to 40 MPa for about 60 minutes.

19. A method for manufacturing a phosphor, comprising the steps of:
mixing a phosphor host material and an emission excitation material formed of a metal oxide, a semiconductor formed of an element belonging to Group 2B (Group 12) of the periodic table and an element belonging to Group 6B (Group 16) of the periodic table, or a semiconductor formed of an element belonging to Group 3B (Group 13) of the periodic table and an element belonging to Group 5B (Group 15) of the periodic table, as raw materials;
baking an obtained mixture with pressure; and
immersing or exposing an obtained baked substance in or to a neutral, acid, or basic solution or gas.

20. The method for manufacturing a phosphor, according to claim 19, wherein the baking with pressure is performed by a hot pressing method, a hot isostatic pressing method, a discharge plasma sintering method, or an impact method.

21. The method for manufacturing a phosphor, according to claim 19, wherein the raw materials are mixed by a wet process and an obtained mixed material is smashed so that a grain size of the obtained mixed material thereof becomes small.

22. The method for manufacturing a phosphor, according to claim 19, wherein the baking is performed at a pressure of about 20 Pa to 40 MPa for about 60 minutes.
